(19) United States
(12) Patent Application Publication
(10) Pub. No.: US 2017/0221642 A1
(43) Pub. Date: Aug. 3, 2017

(54) PHOTOELECTRIC CONVERSION ELEMENT AND PHOTOELECTRIC CONVERSION ELEMENT MODULE COMPRISING SAME

(71) Applicant: SHARP KABUSHIKI KAISHA, Sakai City, Osaka (JP)

(72) Inventors: Yuki WATANABE, Sakai City, Osaka (JP); Ryoichi KOMIYA, Sakai City, Osaka (JP); Atsushi FUKUI, Sakai City, Osaka (JP); Ryohsuke YAMANAKA, Sakai City, Osaka (JP); Hirokazu ICHINOSE, Sakai City, Osaka (JP)

(21) Appl. No.: 15/500,332

(22) PCT Filed: Jul. 1, 2015
(86) PCT No.: PCT/JP2015/068960

§ 371 Date: Jan. 30, 2017

(30) Foreign Application Priority Data
Jul. 30, 2014 (JP) 2014-154947

(51) Int. Cl. H01G 9/20

(52) U.S. Cl. CPC H01G 9/2059; H01G 9/2009; H01G 9/2077; H01G 9/2081

(57) ABSTRACT

A photoelectric conversion element includes a frame-shaped insulating sealing part that is disposed between the plurality of first electrodes and the cover and defines a space inside the photoelectric conversion element, a photoelectric conversion part formed on an upper surface of a first electrode in the space; a second electrode formed in the space, which includes a flat portion and a bent portion, and insulates the photoelectric conversion part from the second electrode, an inter-cell insulating part that insulates the first electrode from the second electrode, a carrier transporting part with which the space is filled, and an insulating bonding part that has at least a portion positioned between the porous insulating part and the cover and is brought into contact with the inter-cell insulating part and with a portion of the flat portion so as to bond the inter-cell insulating part and the second electrode to each other.

### TECHNICAL FIELD

The present invention relates to a photoelectric conversion element and a photoelectric conversion element module comprising the same, particularly, to a wet type photoelectric conversion element and a photoelectric conversion element module comprising the same.

### BACKGROUND ART

Japanese Unexamined Patent Application Publication No. 2011-176288 (Patent Literature 1) is provided as the citation literature disclosing a photoelectric conversion element in which separation of a layer constituting the photoelectric conversion element is suppressed. The photoelectric conversion element disclosed in Patent Literature 1 includes an insulating layer-including substrate which includes an electrically-insulating layer, at least one stress relaxation layer formed on the electrically-insulating layer, a lower electrode formed on the stress relaxation layer, a photoelectric conversion layer which is formed on the lower electrode and is configured from a compound semiconductor layer, and an upper electrode formed on the photoelectric conversion layer.

### CITATION LIST

### Patent Literature

PTL 1: Japanese Unexamined Patent Application Publication No. 2011-176288

### SUMMARY OF INVENTION

### Technical Problem

In the photoelectric conversion element disclosed in Patent Literature 1, suppressing an occurrence of separation between the electrically-insulating layer and the lower electrode (first electrode) is achieved. In a wet type photoelectric conversion element, the upper electrode (second electrode) may be separated.

Considering the above problems, an object of the present invention is to provide a photoelectric conversion element and a photoelectric conversion element module including the photoelectric conversion element, which can suppress an occurrence of separation of the second electrode.

### Solution to Problem

According to the present invention, a photoelectric conversion element includes a transparent substrate having a light-receiving surface; a cover disposed to face the transparent substrate; a plurality of first electrodes formed on a surface of the transparent substrate facing the cover; a frame-shaped insulating sealing part that is disposed between the plurality of first electrodes and the cover and defines a space inside the photoelectric conversion element; a photoelectric conversion part formed on an upper surface of a first electrode among the plurality of first electrodes in the space; a second electrode formed in the space, which includes a flat portion that faces an upper surface of the photoelectric conversion part and a lower surface of the cover, and a bent portion that is bent at an end of the flat portion toward another first electrode adjacent to the first electrode among the plurality of first electrodes and is electrically connected to the another first electrode; a porous insulating part that is positioned between the photoelectric conversion part and the second electrode, and insulates the photoelectric conversion part from the second electrode; an inter-cell insulating part that is in contact with at least a portion of an outer circumference of the photoelectric conversion part and insulates the first electrode from the second electrode; a carrier transporting part with which the space is filled; and an insulating bonding part that has at least a portion positioned between the porous insulating part and the cover and is brought into contact with the inter-cell insulating part and with a portion of the flat portion so as to bond the inter-cell insulating part and the second electrode to each other.

In an aspect of the present invention, the insulating bonding part comes into contact with the first electrode.

In the aspect of the present invention, the insulating bonding part comes into contact with the photoelectric conversion part.

In the aspect of the present invention, a portion of the insulating bonding part is positioned on the flat portion.

According to the present invention, a photoelectric conversion element module includes a plurality of photoelectric conversion elements which are described above, and are electrically connected to each other in series or in parallel.

### Advantageous Effects of Invention

According to the present invention, it is possible to suppress the occurrence of separation of the second electrode.

### BRIEF DESCRIPTION OF DRAWINGS

FIG. 1 is a sectional view illustrating a configuration of a photoelectric conversion element according to Embodiment 1 of the present invention.

FIG. 2 is a diagram viewed from a direction indicated by an arrow II in FIG. 1.

FIG. 3 is a plan view illustrating a pattern in a plan view of an insulating bonding part of the photoelectric conversion element according to Embodiment 1 of the present invention.

FIG. 4 is a sectional view illustrating a configuration of a photoelectric conversion element according to Embodiment 2 of the present invention.

FIG. 5 is a plan view when a pattern in a plan view of an insulating bonding part of the photoelectric conversion element in FIG. 4 is viewed from a direction indicated by an arrow V.

FIG. 6 is a sectional view illustrating a configuration of a photoelectric conversion element according to Embodiments 3 and 4 of the present invention.

FIG. 7 is a plan view when a pattern in a plan view of an insulating bonding part of the photoelectric conversion element according to Embodiment 3 of the present invention in FIG. 6 is viewed from a direction indicated by an arrow VII.

FIG. 8 is a plan view when a pattern in a plan view of an insulating bonding part of the photoelectric conversion element according to Embodiment 4 of the present invention in FIG. 6 is viewed from a direction indicated by an arrow VIII.

FIG. 9 is a plan view illustrating a pattern in a plan view of an insulating bonding part of a photoelectric conversion element according to Comparative Example 1.

FIG. 10 is a plan view illustrating a pattern in a plan view of an insulating bonding part of a photoelectric conversion element according to Embodiment 5 of the present invention.

FIG. 11 is a plan view illustrating a pattern in a plan view of an insulating bonding part of a photoelectric conversion element according to Embodiment 6 of the present invention.

FIG. 12 is a plan view illustrating a pattern in a plan view of an insulating bonding part of a photoelectric conversion element according to Embodiment 7 of the present invention.

FIG. 13 is a plan view illustrating a pattern in a plan view of an insulating bonding part of a photoelectric conversion element according to Example 8.

FIG. 14 is a plan view illustrating a pattern in a plan view of an insulating bonding part of a photoelectric conversion element according to Example 9.

FIG. 15 is a plan view illustrating a pattern in a plan view of an insulating bonding part of a photoelectric conversion element according to Comparative Example 2.

FIG. 16 is a plan view illustrating a pattern in a plan view of an insulating bonding part of a photoelectric conversion element according to Example 10.

FIG. 17 is a plan view illustrating a pattern in a plan view of an insulating bonding part of a photoelectric conversion element according to Example 11.

FIG. 18 is a plan view illustrating a pattern in a plan view of an insulating bonding part of a photoelectric conversion element according to Example 12.

FIG. 19 is a sectional view illustrating a configuration of a photoelectric conversion element according to Embodiment 8 of the present invention.

FIG. 20 is a plan view when a pattern in a plan view of an insulating bonding part of the photoelectric conversion element in FIG. 19 is viewed from a direction indicated by an arrow XX.

FIG. 21 is a plan view illustrating a pattern in a plan view of an insulating bonding part of a photoelectric conversion element according to Embodiment 9 of the present invention.

FIG. 22 is a plan view illustrating a pattern in a plan view of an insulating bonding part of a photoelectric conversion element according to Comparative Example 3.

FIG. 23 is a sectional view illustrating a configuration of a photoelectric conversion element according to Embodiment 10 of the present invention.

FIG. 24 is a plan view when a pattern in a plan view of an insulating bonding part of the photoelectric conversion element in FIG. 23 is viewed from a direction indicated by an arrow XXIV.

FIG. 25 is a sectional view illustrating a configuration of a photoelectric conversion element according to Example 16.

FIG. 26 is a plan view when a pattern of an insulating bonding part of the photoelectric conversion element in FIG. 25 is viewed from a direction indicated by an arrow XXVI.

FIG. 27 is a plan view illustrating an appearance of a photoelectric conversion element module according to Embodiment 11 of the present invention.

FIG. 28 is a sectional view illustrating a configuration of the photoelectric conversion element module according to Embodiment 11 of the present invention.

### DESCRIPTION OF EMBODIMENTS

Hereinafter, a photoelectric conversion element and a photoelectric conversion element module including the photoelectric conversion element according to each embodiment of the present invention will be described with reference to the drawings. In the following descriptions, the same or corresponding parts in the drawings are denoted by the same reference signs, and descriptions thereof will not be repeated. A dimension relationship of a length, a width, a thickness, and the like in the drawings is appropriately changed in order to clarify and simplify the drawings, and does not show an actual dimension relationship.

### Embodiment 1

<Configuration of Photoelectric Conversion Element>

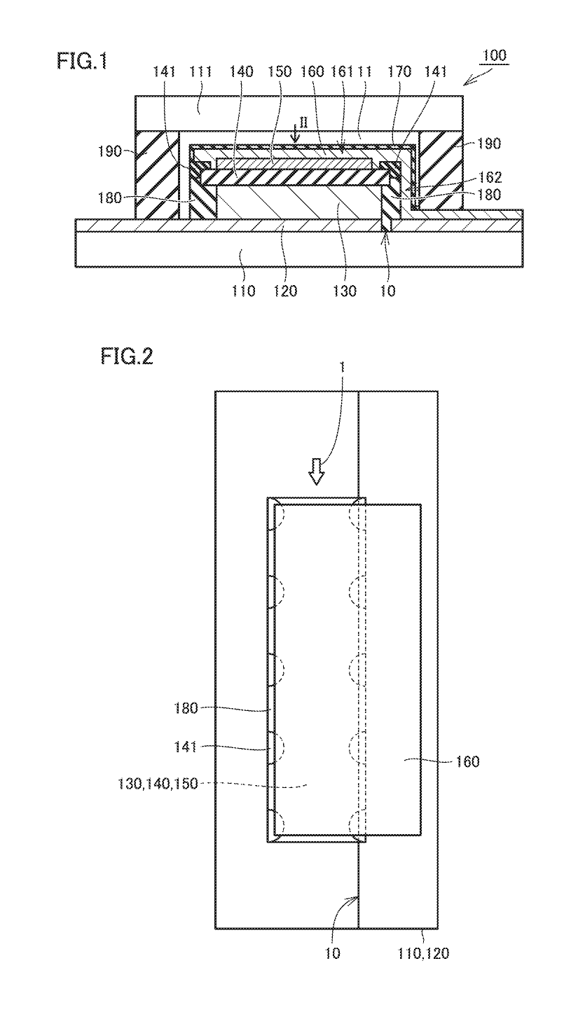

FIG. 1 is a sectional view illustrating a configuration of a photoelectric conversion element according to Embodiment 1 of the present invention. FIG. 2 is a diagram viewed from a direction indicated by an arrow II in FIG. 1.

As illustrated in FIGS. 1 and 2, a photoelectric conversion element 100 includes a transparent substrate 110 having a light-receiving surface, a cover 111 disposed to face the transparent substrate 110, and a plurality of first electrodes 120 formed on a surface on a side facing the cover 111 of the transparent substrate 110. The plurality of first electrodes 120 are separated from each other by a scribe line 10.

The photoelectric conversion element 100 includes a frame-shaped insulating sealing part 190, a photoelectric conversion part 130, and a second electrode 160. The frame-shaped insulating sealing part 190 is disposed between the first electrode 120 and the cover 111, and defines an inside space. The photoelectric conversion part 130 is formed on an upper surface of one first electrode 120 among the plurality of first electrodes 120 in the space. The second electrode 160 includes a flat portion 161 and a bent portion 162. The flat portion 161 faces an upper surface of the photoelectric conversion part 130 and a lower surface of the cover 111. The bent portion 162 is bent from an end portion of the flat portion 161 toward the other first electrode 120 adjacent to the one first electrode 120 among the plurality of first electrodes 120. The second electrode 160 is electrically connected to the other first electrode 120.

The photoelectric conversion element 100 further includes a porous insulating part 140, an inter-cell insulating part 180, and a carrier transporting part 11. The porous insulating part 140 is positioned between the photoelectric conversion part 130 and the second electrode 160, and insulates the photoelectric conversion part 130 from the second electrode 160. The inter-cell insulating part 180 is in contact with at least a portion of an outer circumference of the photoelectric conversion part 130, and insulates the first electrode 120 from the second electrode 160. The space is filled with the carrier transporting part 11.

The photoelectric conversion part 130 includes a porous semiconductor layer. Gap portions of the porous semiconductor layer, the porous insulating part 140, and the second electrode 160 are filled with a carrier transporting material. A protective film 170 is formed on a surface of the second electrode 160. In this embodiment, a catalyst layer 150 is provided between the porous insulating part 140 and the second electrode 160.

The photoelectric conversion element 100 has at least a portion which is positioned between the porous insulating part 140 and the cover 111. The photoelectric conversion element 100 further includes an insulating bonding part 141 which is brought into contact with the inter-cell insulating part 180 and with a portion of the flat portion 161 of the second electrode 160, so as to bond the inter-cell insulating part 180 and the second electrode 160 to each other.

Components of the photoelectric conversion element 100 will be described below in detail.

<Transparent Substrate>

A glass substrate of, for example, soda-lime glass, non-alkali glass, fused quartz glass, and crystalline quartz glass, a heat resistant resin plate, or the like may be used as the transparent substrate 110. The transparent substrate 110 may transmit light of a wavelength which substantially has sensitivity for at least a dye (which will be described later) (transmittance of the light is, for example, equal to or more than 80%, and preferably equal to or more than 90%). The transparent substrate 110 not necessarily has transmittance for light having all wavelengths.

Examples of a material forming a flexible film (also referred to as “a film” below) include tetraacetyl cellulose (TAC), polyethylene terephthalate (PET), polyphenylene sulfide (PPS), polycarbonate (PC), polyarylate (PA), polyetherimide (PEI), phenoxy resin, and polytetrafluoroethylene (PTFE).

In a case where another layer is formed on the transparent substrate 110 with heating, and in a case where a porous semiconductor layer is formed on the transparent substrate 110 with heating at, for example, about 250° C., polytetrafluoroethylene which has heat resistance against a temperature of 250° C. or higher among the above materials forming the film is particularly preferably used.

The transparent substrate 110 may be used when the completed photoelectric conversion element 100 is attached to another structural body. For example, a peripheral portion of the transparent substrate 110 which is a glass substrate and the like can be easily attached to other support materials by using a metal machining component and a screw.

The thickness of the transparent substrate 110 is not particularly limited. Considering optical transparency and the like, the thickness thereof is preferably about 0.05 mm to 5 mm.

<First Electrode>

A material of a transparent conductive layer constituting the first electrode 120 may transmit light of a wavelength which substantially has sensitivity for at least a dye (which will be described later). The transparent conductive layer not necessarily has transmittance for light having all wavelengths. Examples of the material of the first electrode 120 includes indium tin oxide (ITO), tin oxide (SnO₂), fluorine-doped tin oxide (FTO), zinc oxide (ZnO), and tantalum-doped or niobium-doped titanium oxide.

The film thickness of the transparent conductive layer constituting the first electrode 120 is not particularly limited, and is preferably about 0.02 μm to 5 μm. The film resistance of the transparent conductive layer constituting the first electrode 120 becomes preferable as being reduced, and is preferably equal to or less than 40 Ω/sq.

As the transparent substrate, for example, a commercial product in which a first electrode 120 formed from FTO is stacked, in advance, on the transparent substrate 110 formed from soda-lime float glass may be used.

<Scribe Line>

The scribe line 10 is provided in order to separate the transparent conductive layer functioning as the first electrode 120, for each photoelectric conversion element. A method of forming the scribe line 10 is not particularly limited. For example, the transparent conductive layer constituting the first electrode 120 may be formed on the entirety of an upper surface of the transparent substrate 110, and then a portion set as the scribe line 10 in the transparent conductive layer may be removed by a laser scribing method and the like. In addition, a mask may be provided on a portion set as the scribe line 10 on the upper surface of the transparent substrate 110, and then the first electrode 120 may be formed at portions at which the mask is not provided on the upper surface of the transparent substrate 110. Then, the mask may be removed.

<Photoelectric Conversion Part>

The photoelectric conversion part 130 is configured in a manner that a dye, a quantum dot, or the like is absorbed to the porous semiconductor layer, and filling with the carrier transporting material is performed. The photoelectric conversion part 130 according to this embodiment has a rectangular appearance. The length of a short side of the photoelectric conversion part 130 is, for example, 5 mm.

—Porous Semiconductor Layer—

A semiconductor material forming the porous semiconductor layer is not particularly limited as long as the material is generally used as a photoelectric conversion material. Examples of such a material include compounds such as titanium oxide, zinc oxide, tin oxide, iron oxide, niobium oxide, cerium oxide, tungsten oxide, barium titanate, strontium titanate, cadmium sulfide, lead sulfide, zinc sulfide, indium phosphide, copper-indium sulfide (CuInS₂), CuAlO₂, and SrCu₂O₂. As the semiconductor material forming the porous semiconductor layer, the above compounds may be singly used or be used in combination of the above compounds. Among these compounds, from a point of stability and safety, titanium oxide is preferably used as the semiconductor material constituting the porous semiconductor layer.

In a case where titanium oxide is preferably used as the material forming the porous semiconductor layer, titanium oxide may be various types of titanium oxide in a narrow sense, such as anatase type titanium oxide, rutile type titanium oxide, amorphous titanium oxide, metatitanic acid, and orthotitanic acid, may be titanium hydroxide, or may be a titanium hydroxide-containing substance. As the semiconductor material forming the porous semiconductor layer, the above titanium oxide may be singly used or be used in mixture. Regarding anatase type titanium oxide and rutile type titanium oxide, anatase type titanium oxide which is obtained to have any form, by a manufacturing method or a thermal history is generally used.

From a viewpoint of easiness in absorbing a photo-sensitizer, as the material forming the porous semiconductor layer, a substance having a high content percentage of anatase type titanium oxide is preferably used, and a substance having a content percentage of content percentage, which is equal to or more than 80% is more preferably used. A preparing method of titanium oxide is not particularly limited. The preparing method may be well-known methods such as a vapor phase method or a liquid phase method (hydrothermal method or sulfuric acid method). A method which has been developed by Degussa Corporation, and in which obtains titanium oxide by performing high-temperature hydrolysis of chloride may be used.

The form of the porous semiconductor layer may be either of single crystal and polycrystal. However, from a point of stability, difficulty in crystal growing, manufacturing cost, and the like, the porous semiconductor layer is preferably a polycrystalline sintered body, and is particularly preferably polycrystalline sintered body formed from fine powder (from nanoscale to microscale).

The porous semiconductor layer may be configured by using particles which have the same size and are formed from a compound semiconductor material, or may be configured by using particles which have different sizes and are formed from a compound semiconductor material. It is considered that particles having a relatively large size scatter incident light, and thus contribute to improvement of light-harvesting efficiency. If particles having a relatively small size are used, the number of absorption points of the photo-sensitizer is increased. Thus, it is considered that the particles having a relatively small size contribute to improvement of the absorbed amount of the photo-sensitizer.

An average particle diameter of particles having a relatively large size is preferably 10 times or more an average particle diameter of particles having a relatively small size. For example, the average particle diameter of particles having a relatively large size is preferably 100 nm to 500 nm, and the average particle diameter of particles having a relatively small size is preferably 5 nm to 50 nm. Particles having different sizes may be formed from the same material or be formed from different materials. In a case where particles having different sizes are formed from different materials, particles having a relatively small size are preferably configured by a material having a strong absorption action.

The average particle diameter may be calculated by using a spectral (diffraction peaks of XRD (X-ray diffraction)) which is obtained from X-ray diffraction measurement, or may be obtained by direct observation with a scanning electron microscope (SEM).

The thickness of the porous semiconductor layer is not particularly limited. For example, a range of about 0.1 μm to 100 μm is appropriate. Since the photo-sensitizer is absorbed to the porous semiconductor layer, the area of the surface of the porous semiconductor layer is preferably large. For example, the BET specific surface area of the porous semiconductor layer is preferably about 10 m²/g to 200 m²/g.

—Photo-Sensitizer—

The photo-sensitizer is provided to convert optical energy incident to a photoelectric conversion element, into electric energy. As a dye which is absorbed to the porous semiconductor layer and functions as the photo-sensitizer, an organic dye, a metal complex dye, or the like which performs absorption in at least one region of a visible region and an infrared region is exemplified. As the photo-sensitizer, the above dyes may be singly used or be used in combination of two types or more.

The organic dye is, for example, an azo dye, a quinone dye, a quinone imine dye, a quinacridone dye, a squarylium dye, a cyanine dye, a merocyanine dye, a triphenylmethane dye, a xanthene dye, a porphyrin dye, a perylene dye, an indigo dye, a phthalocyanine dye, or a naphthalocyanine dye. The extinction coefficient of the organic dye is generally larger than the extinction coefficient of the metal complex dye.

The metal complex dye is configured in a manner that coordination bonding of molecules (ligand) to transition metal is performed. The transition metal is, for example, Cu, Ni, Fe, Co, V, Sn, Si, Ti, Ge, Cr, Zn, Ru, Mg, Al, Pb, Mn, In, Mo, Y, Zr, Nb, Sb, La, W, Pt, Ta, Ir, Pd, Os, Ga, Tb, Eu, Rb, Bi, Se, As, Sc, Ag, Cd, Hf, Re, Au, Ac, Tc, Te, or Rh. As the metal complex dye, a porphyrin metal complex dye, a phthalocyanine metal complex dye, a naphthalocyanine metal complex dye or a ruthenium metal complex dye is exemplified. Among the dyes, a phthalocyanine metal complex dye or a ruthenium metal complex dye is preferable, and a ruthenium metal complex dye represented by the following formulas (1) to (3) is more preferable.

Examples of a commercial ruthenium metal complex dye include dyes of Ruthenium 535, Ruthenium535-bisTBA, and Ruthenium620-1H3TBA as product names, manufactured by Solaronix Corportion.

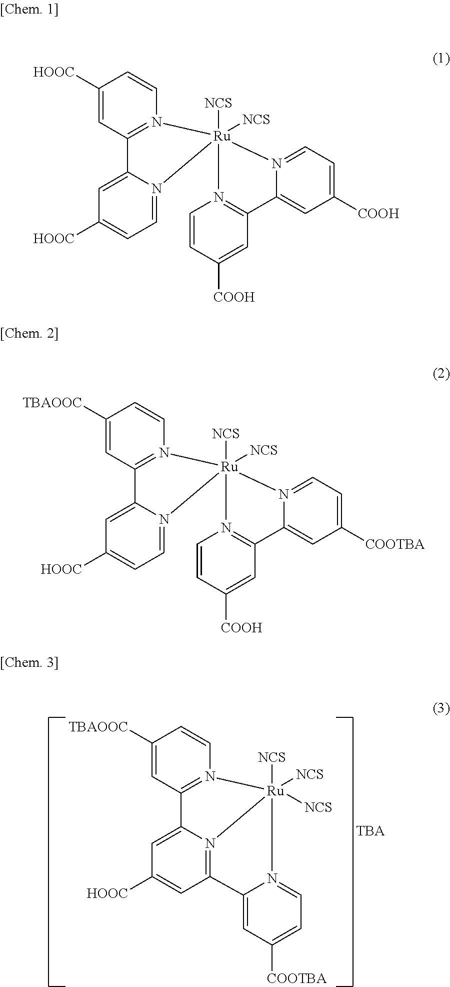

As a method of absorbing the photo-sensitizer to the porous semiconductor layer, for example, a method of immersing the porous semiconductor layer in a solution (dye-absorption solution) in which a dye is dissolved is representatively exemplified. At this time, a dye-absorption solution is preferably heated in a point that the dye-absorption solution is infiltrated to an inner part of a fine hole in the porous semiconductor layer.

In order to rigidly absorb the dye to the porous semiconductor layer, it is preferable that the dye has an interlock group such as a carboxyl group, an alkoxy group, a hydroxyl group, a sulfonic acid group, an ester group, a mercapto group, or a phosphonyl group. The interlock group has a function of providing an electric bond for causing electrons to easily move between an excited state of the dye and a conduction band of the semiconductor material.

As a quantum dot which is absorbed to the porous semiconductor layer, and functions as the photo-sensitizer, CdS, CdSe, PbS, or PbSe is exemplified.

<Porous Insulating Part>

The porous insulating part 140 is provided on the photoelectric conversion part 130, in order to reduce an occurrence of leakage by injecting electrons from the photoelectric conversion part 130 to the catalyst layer 150 and the second electrode 160. Here, the porous insulating part 140 being porous means that a porosity rate is equal to or more than 20%, and means that the specific surface area is 10 m²/g to 100 m²/g. Fine holes of such a porous insulating part 140 are preferably equal to or more than 50 μm, and more preferably 50 μm to 200 μm.

In other words, the porous insulating part 140 is preferably formed from particles having an average particle diameter of 5 nm to 500 nm, and more preferably formed from particles having an average particle diameter of 10 nm to 300 nm. Thus, the porous insulating part 140 can hold the carrier transporting material. The fine holes in the porous insulating part 140 are preferably measured by, for example, a BET method. A method of measuring a porosity rate of the porous insulating part 140 and a method of measuring an average particle diameter of particles constituting the porous insulating part 140 are preferably the methods described in <Photoelectric Conversion Layer>.

The material of the porous insulating part 140 is not particularly limited, and may be glass. As the material, one or two types or more of insulating materials having a high conduction band level, such as zirconium oxide, silicon oxide, aluminum oxide, niobium oxide, or barium titanate may be selectively used. In a case where two types or more of the insulating materials are used, the porous insulating part 140 may be configured by a single layer of a mixture of two types or more materials, or may be configured by a plurality of layers which are formed from different materials and stacked. Preferably, the porous insulating part 140 contains zirconium oxide or titanium oxide having an average particle diameter of 100 nm or more.

The film thickness of the porous insulating part 140 is not particularly limited. However, from a viewpoint of insulating properties, the film thickness thereof is preferably 2 μm to 50 μm, and more preferably 5 μm to 20 μm.

In a case where the porous semiconductor layer constituting the photoelectric conversion part is formed from at least two or more different layers having light scattering properties, and the two or more porous semiconductor layers are stacked from the light-receiving surface side of the photoelectric conversion element, in an order of a layer having high light scattering properties from a layer having low light scattering properties, the porous insulating part may be not provided. In this case, the catalyst layer or the second electrode is directly provided on the photoelectric conversion part which includes the porous semiconductor layer formed from a semiconductor material. The semiconductor material has a large particle diameter, that is, an average particle diameter which is about 100 nm to 500 nm.

The light scattering properties of the porous semiconductor layer may be adjusted by the average particle diameter of the semiconductor material. Specifically, the porous semiconductor layer formed by semiconductor particles having a large average particle diameter has high light scattering properties. The porous semiconductor layer formed by semiconductor particles having a small average particle diameter has low light scattering properties. The porous semiconductor layer formed by semiconductor particles having a large average particle diameter has high light-harvesting efficiency because of more scattering incident light. The porous semiconductor layer formed by semiconductor particles having a small average particle diameter has the large absorbed amount of the dye because of more absorption points of the dye.

The porous semiconductor layer having highest light scattering properties is preferably formed from semiconductor particles having an average particle diameter of 50 nm or more (preferably, 50 nm to 600 nm). Other porous semiconductor layers are preferably formed from at least semiconductor particles having an average particle diameter which is equal to or more than 5 nm and less than 50 nm (preferably, 10 nm to 30 nm).

The layers are stacked from the light-receiving surface side of the photoelectric conversion element in an order of the layer having high light scattering properties from the layer having low light scattering properties, and thus it is possible to effectively use incident light in photoelectric conversion. The particle diameter of semiconductor particles in a porous semiconductor layer positioned on an opposite side of the light-receiving surface is large. Thus, the absorbed amount of the dye is small. Thus, the incident light is only absorbed or reflected by the semiconductor particles in the porous semiconductor layer positioned on the opposite side of the light-receiving surface. In a case where the porous semiconductor layer is formed from titanium oxide particles, the light-absorption wavelength range is equal to or less than about 400 nm. Thus, the incident light is absorbed by the titanium oxide particles or the carrier transporting material in which redox species such as iodine are dissolved, in the porous semiconductor layer on the light-receiving surface side. Accordingly, the incident light hardly reaches the porous semiconductor layer positioned on the opposite side of the light-receiving surface. Accordingly, in such a configuration, leakage occurring by a difference of a basic energy level is not caused, and photoelectric conversion hardly occurs at an interface between the photoelectric conversion layer in which an occurrence of leakage is assumed, and the catalyst layer. Thus, a porous insulating layer may be not provided.

<Catalyst Layer>

In this embodiment, the catalyst layer 150 is provided so as to be interposed between the porous insulating part 140 and the second electrode 160. The material forming the catalyst layer 150 is not particularly limited as long as being a material which allows electrons to be transferred on the surface thereof. For example, a rare metal material such as platinum and palladium, or a carbon material such as carbon black, ketjen black, carbon nanotube, and fullerene may be used. The catalyst layer 150 may be provided to be integrated with the second electrode 160 (in single layer). In a case where a second electrode 160 having a catalyst function is provided, the catalyst layer 150 may be not provided.

As in a case where the catalyst layer 150 is formed by a vapor deposition method, in a case where film strength of the formed catalyst layer 150 is not much strong, if the second electrode 160 is formed on the catalyst layer 150 which has been formed on the porous insulating part 140, the second electrode 160 may be separated from the porous insulating part 140 along with the catalyst layer 150.

<Second Electrode>

The second electrode 160 includes a flat portion 161 facing the photoelectric conversion part 130, and a bent portion 162 bent from an end portion of the flat portion 161 toward another first electrode 120. Specifically, one end of the bent portion 162 is linked to the flat portion 161. Another end of the bent portion 162 is in contact with another first electrode 120 adjacent to one first electrode 120 which is in contact with the photoelectric conversion part 130 facing the flat portion 161.

The material forming the second electrode 160 is not particularly limited as long as having conductivity. For example, composite oxide (ITO) of indium and tin, tin oxide (SnO₂), tin oxide (FTC)) having fluorine doped therein, or metal oxide such as zinc oxide (ZnO) may be provided. In addition, at least one type or more of metal materials among titanium, nickel, tungsten, and tantalum may be contained. A method of forming the second electrode 160 may be a well-known method such as a vapor deposition method, a sputtering method, or a spray method.

The thickness of the second electrode 160 is not particularly limited. However, if the thickness of the second electrode 160 is too thin, electric resistance of the second electrode 160 is increased. If the thickness of the second electrode 160 is too thick, moving of the carrier transporting material is hindered. Considering these points, it is preferable that the thickness of the second electrode 160 is appropriately selected. The thickness of the second electrode 160 is preferably about 0.02 μm to 5 μm. Sheet resistance of a conductive layer constituting the second electrode 160 becomes preferable as being low, and is preferably equal to or less than 40 Ω/sq.

In a case where the second electrode 160 is formed by the vapor deposition method, the second electrode 160 itself becomes porous. Thus, a hole for causing a dye solution, the carrier transporting material, or the like to move may be not separately provided in the second electrode 160. In a case where the second electrode 160 is formed by the vapor deposition method, a hole diameter of a hole which is naturally formed in the second electrode 160 is about 1 nm to 20 nm. The following is concerned. That is, a concern that the material forming the catalyst layer 150 reaches the porous insulating part 140, further, the porous semiconductor layer (photoelectric conversion part 130) through an inside of the hole formed on the second electrode 160 does not occur even when the catalyst layer 150 is formed on the second electrode 160.

In a case where a hole is intentionally formed in the second electrode 160, for example, it is preferable that irradiation with a laser beam is performed so as to partially evaporate second electrode 160. A diameter of a hole formed in this manner is preferably 0.1 μm to 100 μm, and more preferably 1 μm to 50 μm. An interval between holes is preferably 1 μm to 200 μm, and more preferably 10 μm to 30 μm.

A stripe-like opening portion is formed in the second electrode 160, and thus an effect similar to that for the hole is also obtained. In this case, an interval between stripe-like opening portions is preferably 1 μm to 200 μm, and more preferably 10 μm to 30 μm.

In this embodiment, in order to reduce a leakage current from the second electrode 160, a protective film 170 is formed on the surface of the second electrode 160. The protective film 170 is not particularly limited as long as can reduce the leakage current. For example, a film formed from metal oxide, or a film formed from an organic compound is exemplified. As metal oxide, oxide of metal forming the second electrode 160 is exemplified. In this case, the second electrode 160 is heated and oxidized, and thus the protective film 170 is formed.

As the organic compound, a pyridine compound such as 4-tert-butylpyridine (TBP); an imidazole compound such as alkyl imidazole and methyl benzimidazole; or an ionic compound such as guanidine thiocyanate and tetrabutylammonium thiocyanate is exemplified. In this case, the second electrode 160 is coated with a solution in which an organic compound is dissolved, and thus the protective film 170 is formed.

As a solvent for dissolving the organic compound, alcohols such as ethanol; ketones such as acetone; ethers such as diethyl ether and tetrahydrofuran; nitrogen compounds such as acetonitrile; halogenated aliphatic hydrocarbon such as chloroform; aliphatic hydrocarbon such as hexane; aromatic hydrocarbon such as benzene; or water is exemplified. The above solvents may be singly used or be used in mixture of two types or more.

As described above, when the second electrode 160 is heated, the second electrode 160 may be separated. In this case, yield of the photoelectric conversion element is reduced. Thus, the separation is not preferable. In order to suppress an occurrence of separation of the second electrode 160, an insulating bonding part 141 for bonding the second electrode 160 and the inter-cell insulating part 180 to each other is provided.

If necessary, an extraction electrode (not illustrated) is provided in the second electrode 160. The extraction electrode allows extraction of a current from the photoelectric conversion element to the outside thereof. The material of the extraction electrode is not particularly limited as long as being a material having conductivity.

<Inter-Cell Insulating Part>

The inter-cell insulating part 180 is provided so as to insulate the first electrode 120 and the second electrode 160 from each other. Specifically, the inter-cell insulating part 180 insulates on first electrode 120 having an upper surface on which the photoelectric conversion part 130 is formed, and the bent portion 162 of the second electrode 160, from each other.

It is preferable that the inter-cell insulating part 180 is a layer denser than the porous insulating part 140. Examples of the material forming such an inter-cell insulating part 180 include silicone resin, epoxy resin, polyisobutylene resin, hot melt resin, or glass frit. The inter-cell insulating part 180 may be formed by singly using the materials, or may be formed by stacking two or more layers of two types of more materials.

In a case where the inter-cell insulating part 180 is formed before the porous semiconductor layer and the porous insulating part 140 are formed, the inter-cell insulating part 180 is required to have heat resistance against a heating temperature when the porous semiconductor layer and the porous insulating part 140 are formed. The inter-cell insulating part 180 is required to have resistance against ultraviolet rays because of being exposed by ultraviolet rays included in the received light. From the above viewpoints, as the material forming the inter-cell insulating part 180, a glass material is preferable, and a bismuth glass paste is more preferably used.

In the glass material, for example, a glass paste or a medium which is commercially available as the glass paste may be provided. Among the media, considering reactivity with the carrier transporting material and an environmental problem, a glass material which does not contain lead is preferable. In a case where the inter-cell insulating part 180 is formed on the transparent substrate 110 formed from a glass substrate, a baking temperature of the inter-cell insulating part 180 is preferably equal to or lower than 550° C.

As illustrated in FIG. 2, in this embodiment, the inter-cell insulating part 180 is formed to surround the photoelectric conversion part 130 which is rectangular in plan view. As described above, the inter-cell insulating part 180 is brought into contact with the entire circumference of an outer circumference of the photoelectric conversion part 130, and thus it is possible to improve bonding strength between the inter-cell insulating part 180 and the photoelectric conversion part 130.

That is, the photoelectric conversion part 130 is fixed to the transparent substrate 110 with the first electrode 120 interposed between the photoelectric conversion part 130 and the transparent substrate 110. Thus, a contact area between the inter-cell insulating part 180 and the photoelectric conversion part 130 is increased, and thus it is possible to improve bonding strength of the inter-cell insulating part 180 to the transparent substrate 110 through the photoelectric conversion part 130.

<Cover>

The cover 111 has a function of holding the carrier transporting part 11 in the photoelectric conversion element 100, and preventing invasion of water and the like from the outside. Considering a case where the photoelectric conversion element 100 is installed outdoor, tempered glass and the like are preferably used as the cover 111.

It is preferable that the cover 111 does not come into contact with the components on the transparent substrate 110. In this manner, it is possible to hold the sufficient amount of the carrier transporting part 11 in the photoelectric conversion element 100.

It is preferable that the cover 111 includes an inlet for injecting the carrier transporting material constituting the carrier transporting part 11. The inlet is provided in the cover 111, and thus it is possible to inject the carrier transporting material to the photoelectric conversion element 100 by using a vacuum injection method, a vacuum impregnation method, or the like.

In this case, as described above, a gap formed by the cover 111 not coming in contact with the components of the transparent substrate 110 functions as an inflow path of the carrier transporting material. Thus, it is possible to increase an injection rate when the carrier transporting material is injected from the inlet. Accordingly, it is possible to reduce a manufacturing tact of the photoelectric conversion element 100 and a photoelectric conversion element module.

<Insulating Sealing Portion>

The insulating sealing portion 190 is provided so as to combine the transparent substrate 110 and the cover 111 with each other. The insulating sealing portion 190 has a function of holding the carrier transporting part 11 in the photoelectric conversion element 100, and preventing invasion of water and the like from the outside.

As the material forming the insulating sealing portion 190, ultraviolet curable resin, thermosetting resin, or the like is exemplified. For example, silicone resin, epoxy resin, polyisobutylene resin, polyamide resin, polyolefin resin, hot melt resin such as ionomer resin, or glass frit is exemplified. In a case where the insulating sealing portion 190 is configured by using two types or more materials, the two types or more materials may be mixed. In addition, layers formed from the materials may be stacked or be arranged in parallel.

As the ultraviolet curable resin, the model number: 31X-101 which is manufactured by ThreeBond Co., Ltd. may be used. As the thermosetting resin, the model number: 31X-088 which is manufactured by ThreeBond Co., Ltd., epoxy resin which is generally commercially available, or the like may be used.

<Carrier Transporting Part>

The “carrier transporting part” is positioned on an inner side of the insulating sealing portion 190, and is configured in a manner that the carrier transporting material is injected to a region interposed between the first electrode 120 and the cover 111. Thus, at least the photoelectric conversion part 130 and the porous insulating part 140 are also filled with the carrier transporting material.

The carrier transporting material is preferably a conductive material which allows transporting of ions. For example, a liquid electrolyte, a solid electrolyte, a gel electrolyte, a molten-salt gel electrolyte, or the like is preferably used.

The liquid electrolyte is preferably a liquid matter including redox species. The liquid electrolyte is not particularly limited as long as can be generally used in a cell, a solar cell, or the like. Specifically, the liquid electrolyte is preferably a matter formed from redox species and a solvent which can dissolve the redox species; a matter formed from redox species and a molten salt which can dissolve the redox species; or a matter formed from redox species, the solvent, and the molten salt.

Examples of the redox species include I⁻/I³⁻ series, Br²⁻/Br³⁻ series, Fe²⁺/Fe³⁺ series, quinone/hydroquinone series, or the like. Specifically, the redox species may be a combination of iodine (I₂) and metal iodide such as lithium iodide (LiI), sodium iodide (NaI), potassium iodide (KI), or calcium iodide (CaI₂). The redox species may be a combination of iodine and a tetraalkyl ammonium salt of tetraethyl ammonium iodide (TEAI), tetrapropyl ammonium iodide (TPAI), tetrabutyl ammonium iodide (TBAI), tetrahexyl ammonium iodide (THAI), or the like. The redox species may be a combination of bromine and metal bromide such as lithium bromide (LiBr), sodium bromide (NaBr), potassium bromide (KBr), or calcium bromide (CaBr₂). Among the substances, a combination of LiI and I₂ is particularly preferable.

Examples of the solvent which can dissolve the redox species include a carbonate compound such as propylene carbonate; a nitrile compound such as acetonitrile; alcohols such as ethanol; water; or an aprotic polar substance. Among the substances, a carbonate compound or a nitrile compound is particularly preferable. A combination of two types or more of the solvents may be used.

The solid electrolyte is a conductive material which allows transporting of electrons, holes, or ions. The solid electrolyte may be used as an electrolyte of a photoelectric conversion element. It is preferable that the solid electrolyte does not have fluidity. Specifically, as the solid electrolyte, a hole transport material such as polycarbazole; an electron transport material such as tetranitrofuorolenone; conductive polymer such as polyrol; a polyelectrolyte in which a liquid electrolyte is solidified by a polymeric compound; copper iodide; p-type semiconductor such as copper thiocyanate; an electrolyte in which a liquid electrolyte containing a molten salt is solidified by fine particles is exemplified.

The gel electrolyte is normally formed from an electrolyte and a gelling agent. The electrolyte may be, for example, the liquid electrolyte, or the solid electrolyte.

Examples of the gelling agent include crosslinked polyacrylic resin derivatives, crosslinked polyacrylonitrile derivatives, polyalkylene oxide derivatives, silicone resins, or a polymeric gelling agent such as polymer in which a nitrogen-containing heterocyclic quaternary compound salt structure is provided at a side chain.

The molten-salt gel electrolyte is normally formed from the gel electrolyte as described above, and a normal-temperature molten salt. Examples of the normal-temperature molten salt include pyridinium salts or nitrogen-containing heterocyclic quaternary ammonium salts.

It is preferable that the electrolyte contains an additive described below, if necessary. As the additive, a nitrogen-containing aromatic compound such as t-butylpyridine (TBP) may be provided. In addition, an imidazole salt such as dimethylpropylimidazole iodide (DMPII), methylpropylimidazole iodide (MPII), ethylmethylimidazole iodide (EMII), ethylimidazole iodide (EII), or hexylmethylimidazole iodide (HMII) may be provided.

The concentration of the electrolyte is preferably in a range of 0.001 mol/liter to 1.5 mol/liter, and particularly preferably in a range of 0.01 mol/liter to 0.7 mol/liter. In a case where the catalyst layer of the second electrode 160 is provided on the light-receiving surface side in the photoelectric conversion element according to the present invention, the incident light reaches the porous semiconductor layer (dye is absorbed to the porous semiconductor layer) through an electrolyte solution in the carrier transporting part, and carriers are excited. Thus, in the photoelectric conversion element in which the catalyst layer is provided on the light-receiving surface side, performance of the photoelectric conversion element may depend on the concentration of the electrolyte. Considering this point, it is preferable that the concentration of the electrolyte is set.

<Insulating Bonding Part>

The insulating bonding part 141 is provided so as to bond the inter-cell insulating part 180 and the second electrode 160 to each other. It is preferable that the insulating bonding part 141 is a layer denser than the porous insulating part 140. Examples of the material forming such an insulating bonding part 141 include silicone resin, epoxy resin, polyisobutylene resin, hot melt resin, or glass frit. The insulating bonding part 141 may be formed by singly using the materials, or may be formed by stacking two or more layers of two types of more materials.

The insulating bonding part 141 is required to have resistance against ultraviolet rays because of being exposed by ultraviolet rays included in the received light. From the above viewpoints, as the material forming the insulating bonding part 141, a glass material is preferable, and a bismuth glass paste is more preferably used.

In the glass material, for example, a glass paste or a medium which is commercially available as the glass paste may be provided. Among the media, considering reactivity with the carrier transporting material and an environmental problem, a glass material which does not contain lead is preferable. In a case where the insulating bonding part 141 is formed on the transparent substrate 110 formed from a glass substrate, a baking temperature of the insulating bonding part 141 is preferably equal to or lower than 550° C.

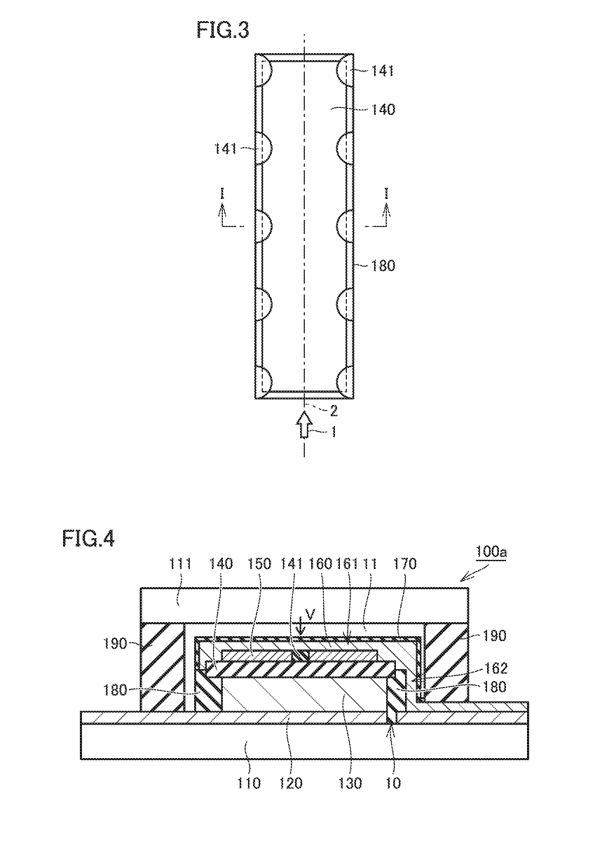

FIG. 3 is a plan view illustrating a pattern in a plan view of the insulating bonding part of the photoelectric conversion element according to Embodiment 1 of the present invention. FIG. 3 illustrates only the porous insulating part 140, the inter-cell insulating part 180, and the insulating bonding part 141. In FIG. 3, Injection direction 1 of the carrier transporting material and Bisector 2 of a short side of the photoelectric conversion part 130 are illustrated.

As illustrated in FIGS. 2 and 3, in this embodiment, a plurality of insulating bonding parts 141 is positioned at an interval along a long side of the photoelectric conversion part 130 in a plan view. Each of the plurality of insulating bonding parts 141 has a semicircular appearance which has a center on an outer circumference of the inter-cell insulating part 180, in a plan view. The plurality of insulating bonding parts 141 is positioned to have a relationship of line symmetry based on Bisector 2, in a plan view.

As illustrated in FIG. 1, in this embodiment, each of the plurality of insulating bonding parts 141 is provided along an upper surface of the inter-cell insulating part 180 from an upper surface of the porous insulating part 140. Each of the plurality of insulating bonding parts 141 is in contact with the flat portion 161 of the second electrode 160.

The plurality of insulating bonding parts 141 is caused to be in contact with the inter-cell insulating part 180 and the second electrode 160, and thus it is possible to improve bonding strength to the transparent substrate 110 of the second electrode 160 through the insulating bonding part 141, the inter-cell insulating part 180, and the photoelectric conversion part 130. Thus, it is possible to suppress an occurrence of separation of the second electrode 160.

Each of the plurality of insulating bonding parts 141 may be in contact with the first electrode 120. In this case, each of the plurality of insulating bonding parts 141 is provided along an upper surface of the first electrode 120 from the upper surface of the porous insulating part 140. The plurality of insulating bonding parts 141 is caused to be in contact with the first electrode 120 and the second electrode 160, and thus it is possible to improve bonding strength to the transparent substrate 110 of the second electrode 160 through the insulating bonding part 141 and the first electrode 120. Thus, it is possible to suppress an occurrence of separation of the second electrode 160.

Each of the plurality of insulating bonding parts 141 is brought into contact with the carrier transporting material, and thus it is preferable that each of the plurality of insulating bonding parts 141 is provided not to hinder injection of the carrier transporting material. In this embodiment, the plurality of insulating bonding parts 141 is arranged as described above, and thus a length obtained by the plurality of insulating bonding parts 141 intersecting with Injection direction 1 of the carrier transporting material is reduced, and an increase of flow resistance of the carrier transporting material is suppressed. Each of the plurality of insulating bonding parts 141 is set to have a semicircular shape, and thus the increase of the flow resistance of the carrier transporting material is also suppressed. As a result, it is possible to suppress an increase of an injection time of the carrier transporting material.

In this embodiment, in a plan view, the plurality of insulating bonding parts 141 is positioned to have a relationship of line symmetry based on Bisector 2 of the short side of the photoelectric conversion part 130, and thus it is possible to suppress an occurrence of injection irregularity of the carrier transporting material.

From a viewpoint of photoelectric conversion efficiency of the photoelectric conversion element 100, in a plan view, an area of a portion at which the plurality of insulating bonding parts 141 and the photoelectric conversion part 130 overlap each other is preferably small. However, if the contact area between the plurality of insulating bonding parts 141 and the second electrode 160 is too small, sufficiently improving bonding strength of the second electrode 160 to the transparent substrate 110 is not possible. Thus, it is preferable that the area of the portion at which the plurality of insulating bonding parts 141 and the photoelectric conversion part 130 overlap each other is small in a range which allows an occurrence of separation of the second electrode to be suppressed.

The shape and the disposition of the insulating bonding part 141 are not limited to the above descriptions, and a shape and disposition which allow the occurrence of separation of the second electrode 160 to be suppressed may be provided.

<Manufacturing Method of Photoelectric Conversion Element>

A manufacturing method of the photoelectric conversion element 100 illustrated in FIGS. 1 to 3 will be described.

A transparent conductive layer constituting a first electrode 120 is formed on a transparent substrate 110. Here, a method of forming the transparent conductive layer is not particularly limited, and is preferably a well-known sputtering method, a well-known spray method, or the like, for example. In a case where a metal lead wire (not illustrated) is provided in the transparent conductive layer, the metal lead wire may be formed on the transparent substrate 110 by, for example, a well-known sputtering method or a well-known vapor deposition method, and then the transparent conductive layer may be formed on the transparent substrate 110 including the obtained metal lead wire. In addition, after a transparent conductive layer is formed on the transparent substrate 110, a metal lead wire may be formed on the transparent conductive layer.

Then, a portion of the transparent conductive layer is cut off by a laser scribing method, so as to form a scribe line 10. Thus, a plurality of first electrodes 120 is formed.

Then, a porous semiconductor layer is formed on the first electrode 120. A method of forming the porous semiconductor layer is not particularly limited. A paste containing a particulate semiconductor material may be applied onto the first electrode 120 by a screen printing method, an ink jet method, or the like, and then may be baked. In addition, a sol-gel method or an electrochemical oxidation-reduction reaction may be used instead of baking. Among the above methods, from a viewpoint in that a porous semiconductor layer having a thick thickness can be formed at low cost, a screen printing method using a paste is particularly preferable.

A method of forming a porous semiconductor layer in a case of using titanium oxide as the semiconductor material will be specifically described below.

Firstly, 125 mL of titanium isopropoxide (manufactured by Kishida Chemical Co., Ltd.) is dropped into 750 mL of a 0.1 M nitric acid aqueous solution (manufactured by Kishida Chemical Co., Ltd.), and then is heated at 80° C. for eight hours. Thus, a sol liquid is prepared. The obtained sol liquid is heated in a titanium autoclave at 230° C. for 11 hours, so as to grow a titanium oxide particle. Ultrasonic dispersion is performed for 30 minutes, thereby a colloidal solution is prepared. The colloidal solution contains titanium oxide particles having an average particle diameter (average primary particle diameter) of 15 nm. Ethanol of the amount corresponding to twice the colloidal solution is added to the obtained colloidal solution, and centrifugation is performed on the resultant obtained by adding, at the number of rotations of 5000 rpm. Thus, titanium oxide particles are obtained.

Then, the obtained titanium oxide particles are washed. Then, the titanium oxide particles are mixed with a medium in which ethyl cellulose and terpineol is dissolved in dehydrated ethanol, and a mixture is stirred. Thus, the titanium oxide particles are dispersed. Then, the liquid mixture is heated under a condition of vacuum, so as to evaporate ethanol, and thus a titanium oxide paste is obtained. As the final composition, for example, the concentration of each of the materials is adjusted such that the concentration of titanium oxide solid to be 20 wt %, the concentration of ethyl cellulose is 10 wt %, and the concentration of terpineol is 64 wt %.

Here, as a solvent used for preparing the titanium oxide paste, in addition to the above substances, a glyme solvent such as ethylene glycol monomethyl ether; an alcohol solvent such as isopropyl alcohol; a solvent mixture of isopropyl alcohol/toluene and the like; water or the like is exemplified. In a case where a paste containing semiconductor particles other than titanium oxide is prepared, the above-described solvents may be used.

Then, the titanium oxide paste is applied onto the transparent conductive layer by the above method, is dried, and then is baked. Thus, a porous semiconductor layer formed from titanium oxide is obtained. Here, a drying condition and a baking condition, for example, conditions of a temperature, a period, an atmosphere, and the like are appropriately adjusted in accordance with a material or a semiconductor material of a support material to be used. It is preferable that baking is performed at an air atmosphere or an atmosphere of an inert gas, in a range of about 50° C. to 800° C., for a period of about 10 seconds to 12 hours, for example. Drying and baking may be separately performed once at the constant temperature, or may be separately performed twice or more with changing the temperature.

Then, an inter-cell insulating part 180 is provided on the scribe line 10. A method of forming the inter-cell insulating part 180 is not particularly limited, and a well-known method is exemplified. Specifically, a method in which a paste containing an insulating material which forms the inter-cell insulating part 180 is applied onto the scribe line 10 by a screen printing method, an ink jet method, or the like, and then baking is performed may be provided. In addition, a sol-gel method or an electrochemical oxidation-reduction reaction may be used instead of baking. Among the above methods, from a viewpoint in that the inter-cell insulating part 180 can be formed at low cost, a screen printing method using a paste is particularly preferable.

Then, a porous insulating part 140 is formed on the porous semiconductor layer. A method of forming the porous insulating part 140 is not particularly limited, and a well-known method is exemplified. Specifically, a method in which a paste containing an insulating material which forms the porous insulating part 140 is applied onto the porous semiconductor layer by a screen printing method, an ink jet method, or the like, and then baking is performed may be provided. In addition, a sol-gel method or an electrochemical oxidation-reduction reaction may be used instead of baking. Among the above methods, from a viewpoint in that the porous insulating part 140 can be formed at low cost, a screen printing method using a paste is particularly preferable.

Then, an insulating bonding part 141 is provided from the porous insulating part 140 along the inter-cell insulating part 180. A method of forming the insulating bonding part 141 is not particularly limited, and a well-known method is exemplified. Specifically, a method in which a paste containing an insulating material which forms the insulating bonding part 141 is applied onto the porous insulating part 140 and onto the inter-cell insulating part 180 by a screen printing method, an ink jet method, or the like, and then baking is performed may be provided. In addition, a sol-gel method or an electrochemical oxidation-reduction reaction may be used instead of baking. Among the above methods, from a viewpoint in that the porous insulating part 140 can be formed at low cost, a screen printing method using a paste is particularly preferable.

Then, a second electrode 160 is formed on the porous insulating part 140 and on the insulating bonding part 141. A method of forming the second electrode 160 is not particularly limited, and a vapor deposition method, a printing method, or the like may be provided. If the second electrode 160 is manufactured by the vapor deposition method, the second electrode 160 itself is porous. Thus, a hole for allowing a dye solution or a carrier transporting material to move may be not separately provided in the second electrode 160. In a case where the hole is formed in the second electrode 160, it is preferable that a method of performing irradiation with a laser beam so as to partially evaporate second electrode 160 is used.

Then, a protective film 170 is formed on the surface of the second electrode 160. A method of forming the protective film is not particularly limited, and a method which allows the protective film to be formed in at least a portion of the surface of the second electrode 160 may be provided.

Specifically, as a method of forming a protective film formed from metal oxide, a method of heating the second electrode 160 so as to form metal oxide on the surface; a method of coating the second electrode 160 with a solution containing metal ions, metal alkoxide, and the like, and then heating the second electrode 160; and a method of coating the heated second electrode 160 with a solution containing metal ions, metal alkoxide, and the like is exemplified.

Among the methods of forming a protective film formed from metal oxide, from a viewpoint of easiness of a process, the method of heating the second electrode 160 and oxidizing the surface so as to form metal oxide is preferable. In this case, metal oxide to be formed is formed from oxides of metal constituting the second electrode. As a heating condition for forming the protective film, a temperature, a period, an atmosphere, and the like may be appropriately selected in accordance with the purpose.

As a method of forming a protective film formed from an organic compound, a method of immersing the second electrode 160 into a solution in which an organic compound is dissolved, and performing drying so as to form the protective film; and a method of coating the heated second electrode 160 with a solution in which an organic compound is dissolved are exemplified. When the second electrode 160 is immersed into the solution, each substrate may be immersed in the solution.

Then, a dye is absorbed to the porous semiconductor layer. As a method of absorbing a dye, for example, a method of immersing the porous semiconductor layer into a solution (dye-absorption solution) is exemplified. As a solvent which dissolves a dye, a solvent which can dissolve a dye is preferably used. Specifically, alcohols such as ethanol; ketones such as acetone; ethers such as diethyl ether and tetrahydrofuran; a nitrogen compounds such as acetonitrile; halogenated aliphatic hydrocarbon such as chloroform; aliphatic hydrocarbon such as hexane; aromatic hydrocarbon such as benzene; esters such as ethyl acetate; or water is exemplified. A mixture of two types or more of the solvents may be used.

The concentration of a dye in dye-absorption solution may be appropriately adjusted in accordance with the types of a dye and a solvent to be used. However, in order to improve an absorption function of a dye to the porous semiconductor layer, the concentration of a dye is preferably as high as possible, for example, is preferably equal to or more than 5×10⁻⁴ mol/liter.

Then, an insulating sealing portion 190 is provided at a predetermined position. Specifically, firstly, a heat-sealable film, ultraviolet curable resin, or the like is cut out so as to have a form of surrounding a stacked body (the stacked body is configured by stacking the photoelectric conversion part 130, the porous insulating part 140, and the second electrode 160) formed on the transparent substrate 110, thereby the insulating sealing portion 190 is manufactured.

In a case where silicone resin, epoxy resin, or glass frit is used as the material of the insulating sealing portion 190, a pattern of the insulating sealing portion 190 may be formed by a dispenser. In a case where hot melt resin is used as the material of the insulating sealing portion 190, a hole obtained by performing patterning on a sheet member which is formed from hot melt resin is opened, and thus the insulating sealing portion 190 may be formed.

The insulating sealing portion 190 formed in such a manner is disposed between the first electrode 120 and the cover 111 on the transparent substrate 110, so as to adhere the transparent substrate 110 and the cover 111 to each other. Heating or irradiation with an ultraviolet ray causes the insulating sealing portion 190 to be fixed to the transparent substrate 110 and the cover 111.

Then, a carrier transporting material is injected from an injection hole which is provided at the cover 111 in advance. A portion which is positioned on an inner side of the insulating sealing portion 190 and is interposed between the first electrode 120 and the cover 111 is filled with the carrier transporting material, and then, the injection hole is sealed by ultraviolet curable resin. Filling with the carrier transporting material causes a carrier transporting part 11 to be formed on the second electrode 160, and causes the carrier transporting material to be held by the photoelectric conversion part 130 and the porous insulating part 140. Thus, the photoelectric conversion element 100 illustrated in FIGS. 1 to 3 is manufactured.

A photoelectric conversion element according to Embodiment 2 of the present invention will be described below. The photoelectric conversion element according to this embodiment is different from the photoelectric conversion element 100 according to Embodiment 1 only in a point of a pattern and disposition of the insulating bonding part. Thus, descriptions for other components will not be repeated.

### Embodiment 2

FIG. 4 is a sectional view illustrating a configuration of a photoelectric conversion element according to Embodiment 2 of the present invention. FIG. 5 is a plan view when a pattern in a plan view of an insulating bonding part of the photoelectric conversion element in FIG. 4 is viewed from a direction indicated by an arrow V. FIG. 5 illustrates only a porous insulating part 140, an inter-cell insulating part 180, and an insulating bonding part 141. In FIG. 5, Injection direction 1 of a carrier transporting material and Bisector 2 of a short side of a photoelectric conversion part 130 are illustrated.

As illustrated in FIGS. 4 and 5, in a photoelectric conversion element 100a according to Embodiment 2 of the present invention, one insulating bonding part 141 is provided so as to link short sides of the photoelectric conversion part 130 to each other. The one insulating bonding part 141 is provided so as to have a straight line in a plan view and is positioned on Bisector 2 of the short side of the photoelectric conversion part 130.

As illustrated in FIG. 4, in this embodiment, one insulating bonding part 141 is provided on an upper surface of the porous insulating part 140. The one insulating bonding part 141 is in contact with a flat portion 161 of a second electrode 160.

One insulating bonding part 141 is brought into contact with the second electrode 160, and thus it is possible to improve bonding strength of the second electrode 160 to the transparent substrate 110 through the insulating bonding part 141, the porous insulating part 140, and the photoelectric conversion part 130. Thus, it is possible to suppress an occurrence of separation of the second electrode 160.

In this embodiment, one insulating bonding part 141 is provided so as to have a straight line shape which is parallel with Injection direction 1 of the carrier transporting material, and thus an increase of flow resistance of the carrier transporting material is suppressed. As a result, it is possible to suppress an increase of an injection time of the carrier transporting material.

A photoelectric conversion element according to Embodiment 3 of the present invention will be described below. The photoelectric conversion element according to this embodiment is different from the photoelectric conversion element 100 according to Embodiment 1 only in a point of a pattern and disposition of the insulating bonding part. Thus, descriptions for other components will not be repeated.

### Embodiment 3

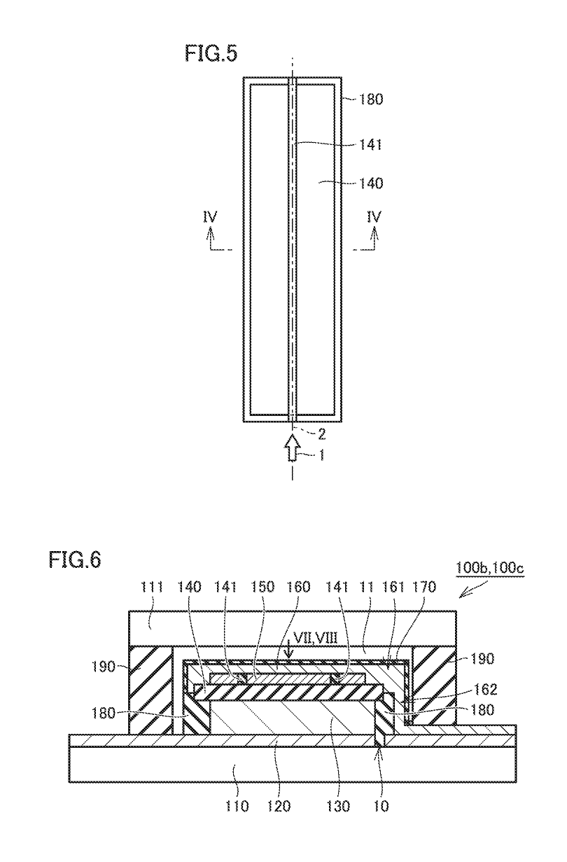

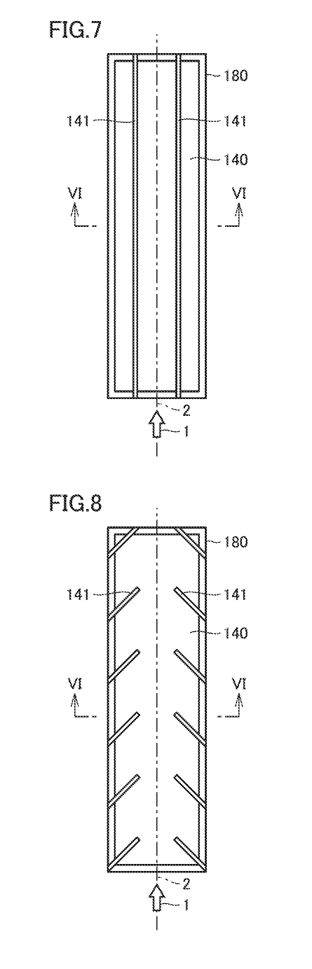

FIG. 6 is a sectional view illustrating a configuration of a photoelectric conversion element according to Embodiments 3 and 4 of the present invention. FIG. 7 is a plan view when a pattern in a plan view of an insulating bonding part of the photoelectric conversion element according to Embodiment 3 of the present invention in FIG. 6 is viewed from a direction indicated by an arrow VII. FIG. 7 illustrates only a porous insulating part 140, an inter-cell insulating part 180, and an insulating bonding part 141. In FIG. 7, Injection direction 1 of a carrier transporting material and Bisector 2 of a short side of a photoelectric conversion part 130 are illustrated.

As illustrated in FIGS. 6 and 7, in a photoelectric conversion element 100b according to Embodiment 3 of the present invention, two insulating bonding parts 141 are provided in parallel with each other so as to link short sides of the photoelectric conversion part 130 in a plan view. Two insulating bonding parts 141 are positioned to have a relationship of line symmetry based on Bisector 2, in a plan view.

As illustrated in FIG. 6, in this embodiment, two insulating bonding parts 141 are provided on an upper surface of the porous insulating part 140. The two insulating bonding parts 141 are in contact with the flat portion 161 of the second electrode 160.

Two insulating bonding parts 141 are brought into contact with the second electrode 160, and thus it is possible to improve bonding strength of the second electrode 160 to the transparent substrate 110 through the insulating bonding part 141, the porous insulating part 140, and the photoelectric conversion part 130. Thus, it is possible to suppress an occurrence of separation of the second electrode 160.

In this embodiment, two insulating bonding part 141 are provided so as to have a straight line shape which is parallel with Injection direction 1 of the carrier transporting material, and thus an increase of flow resistance of the carrier transporting material is suppressed. As a result, it is possible to suppress an increase of an injection time of the carrier transporting material.

A photoelectric conversion element according to Embodiment 4 of the present invention will be described below. The photoelectric conversion element according to this embodiment is different from the photoelectric conversion element 100 according to Embodiment 1 only in a point of a pattern and disposition of the insulating bonding part. Thus, descriptions for other components will not be repeated.

### Embodiment 4

FIG. 8 is a plan view when a pattern in a plan view of an insulating bonding part of the photoelectric conversion element according to Embodiment 4 of the present invention in FIG. 6 is viewed from a direction indicated by an arrow VIII. FIG. 8 illustrates only a porous insulating part 140, an inter-cell insulating part 180, and an insulating bonding part 141. In FIG. 8, Injection direction 1 of a carrier transporting material and Bisector 2 of a short side of a photoelectric conversion part 130 are illustrated.

As illustrated in FIGS. 6 and 8, in a photoelectric conversion element 100c according to Embodiment 4 of the present invention, a plurality of insulating bonding parts 141 is positioned at an interval along each of long sides of a photoelectric conversion part 130 in a plan view. Each of the plurality of insulating bonding parts 141 is inclined from an upper part of the inter-cell insulating part 180 toward the center side of the photoelectric conversion part 130, so as to be positioned on a tip end side in Injection direction 1 of the carrier transporting material. The plurality of insulating bonding parts 141 is positioned to have a relationship of line symmetry based on Bisector 2, in a plan view.

In this embodiment, each of the plurality of insulating bonding parts 141 is formed along the upper surface of the inter-cell insulating part 180 from the upper surface of the porous insulating part 140. Each of the plurality of insulating bonding parts 141 is in contact with the flat portion 161 of the second electrode 160.

The plurality of insulating bonding parts 141 is caused to be in contact with the inter-cell insulating part 180 and the second electrode 160, and thus it is possible to improve bonding strength to the transparent substrate 110 of the second electrode 160 through the insulating bonding part 141, the inter-cell insulating part 180, and the photoelectric conversion part 130. Thus, it is possible to suppress an occurrence of separation of the second electrode 160.

Each of the plurality of insulating bonding parts 141 may be in contact with the first electrode 120. In this case, each of the plurality of insulating bonding parts 141 is provided along an upper surface of the first electrode 120 from the upper surface of the porous insulating part 140. The plurality of insulating bonding parts 141 is caused to be in contact with the first electrode 120 and the second electrode 160, and thus it is possible to improve bonding strength to the transparent substrate 110 of the second electrode 160 through the insulating bonding part 141 and the first electrode 120. Thus, it is possible to suppress an occurrence of separation of the second electrode 160.

In this embodiment, a plurality of insulating bonding parts 141 is provided to be inclined as described above, and thus an increase of flow resistance of the carrier transporting material is suppressed. As a result, it is possible to suppress an increase of an injection time of the carrier transporting material.

Here, Experiment Example 1 in which each of photoelectric conversion elements in Examples 1 to 4 according to Embodiments 1 to 4, and a photoelectric conversion element in Comparative Example 1 was evaluated regarding photoelectric conversion efficiency, a non-separation rate, and an increase rate of an injection period of the carrier transporting material will be described. The non-separation rate corresponds to establishment of separation of a second electrode occurring in a photoelectric conversion element.

### Experiment Example 1

In Experiment Example 1, photoelectric conversion elements according to Examples 1 to 4 and Comparative Example 1 were manufactured as follows, and photoelectric conversion efficiency, a non-separation rate, and an increase rate of an injection period of a carrier transporting material were evaluated.

### Example 1

<Manufacturing of Photoelectric Conversion Element>

A transparent electrode substrate (SnO₂ film-including glass, manufactured by Nippon Sheet Glass Co., Ltd.) in which a transparent conductive layer which is formed from SnO₂ and constitutes a first electrode 120 was formed on a transparent substrate 110 formed from glass was prepared. A portion (width is 200 μm) of the transparent conductive layer in the transparent electrode substrate was cut off.

Then, a commercial glass paste (manufactured by Noritake Co., Ltd, average particle diameter of 18 nm) was applied onto the first electrode 120 by using a screen plate and a screen printer (manufactured by Newlong Seimitsu Kogyo Co., Ltd., model number: LS-34TVA). Then, leveling was performed at room temperature for one hour. The screen plate had a pattern of an inter-cell insulating part 180 (as in arrangement illustrated in FIGS. 2 and 3, including a closing portion of 5 mm×50 mm at a rectangular opening portion of 7 mm×54 mm). Then, after the obtained coated film was dried in an oven set to be 80° C. for 20 minutes, baking was performed in an air for 60 minutes, by using a baking furnace (manufactured by Denken Corp., model number: KDF P-100) set to be 500° C.

Then, coating with a commercial titanium oxide paste (manufactured by Solaronix Corp., product name: D/SP) was performed by using a screen plate, similarly to that with the glass paste, and then leveling was performed at room temperature for one hour. The screen plate has an opening portion of 5 mm×50 mm. Then, after the obtained coated film was dried in an oven set to be 80° C. for 20 minutes, baking was performed in an air for 60 minutes, by using a baking furnace set to be 500° C. The coating and baking of a titanium oxide paste was repeated three times, and then coating, leveling, drying, and baking was performed under similar conditions by using a commercial titanium oxide paste (manufactured by Solaronix Corp., product name: R/SP) having a large particle diameter (average particle diameter of 100 nm), and thus a porous semiconductor layer having a film thickness of 25 μm was obtained.

Then, a paste containing zirconia particles (average particle diameter of 50 nm) was applied onto the porous semiconductor layer by using a screen plate and a screen printer, and then leveling was performed at room temperature for one hour. The screen plate had a pattern (including an opening portion of 5.1 mm×50.1 mm). Then, after the obtained coated film was dried in an oven set to be 80° C. for 20 minutes, baking was performed in an air for 60 minutes, by using a baking furnace set to be 500° C. Thus, a porous insulating part 140 having a film thickness of 5 μm, and a patterned insulating bonding part 141 which has a shape illustrated in FIGS. 2 and 3, and has a film thickness of 13 μm were obtained.

A mask was installed on the porous insulating part 140 in which the insulating bonding part 141 is provided, so as to have a planar shape which was the same as that of the porous insulating part 140. The mask has an opening portion of 5 mm×50 mm. Platinum was deposited at a deposition rate of 0.1 Å/S by using a deposition machine (manufactured by ULVAC, Inc., model name: ei-5), thereby a catalyst layer 150 having a thickness of about 5 nm was formed.

Then, titanium was deposited on the porous insulating part 140 on which the catalyst layer 150 was formed, and on a transparent conductive layer (first electrode 120) of another photoelectric conversion element 100, at a deposition rate of 0.1 Å/S by using a deposition machine. Thus, a second electrode 160 having a thickness of about 2 μm was formed.

The second electrode 160 was preferably formed such that an area in contact with the inter-cell insulating part 180 was as small as possible, in a range being less than the length (54 mm) of the inter-cell insulating part 180 in a longitudinal direction, in order to prevent an occurrence of a short circuit with the first electrode 120. If a short circuit occurs between the first electrode 120 and the second electrode 160, a portion of the second electrode 160 is removed by a method such as layer scribing, and thus it is possible to perform an operation again.

In the photoelectric conversion element according to Example 1, the second electrode 160 was formed from starting points toward the scribe line 10 side up to a position which was separated over the scribe line 10 by 15 mm from the center position of the scribe line 10 (rectangular shape of 20.5 mm×52.8 mm). As the starting points, two points positioned on the scribe line 10 side by 0.6 mm from two edges positioned to be farthest from the scribe line 10 among four edges of the inter-cell insulating part 180 were set. Such formation was performed in order to reduce a probability of an occurrence of a short circuit between the first electrode 120 and the second electrode 160, and to easily perform an operation again.

A dye (manufactured by Solaronix Corp., product name: Ruthenium620 1H3TBA) of the formula (1) was dissolved in a solvent mixture obtained by mixing acetonitrile (manufactured by Aldrich Corp.) and t-butyl alcohol (manufactured by Aldrich Corp.) at a volume ratio of 1:1, so as to have concentration of 4×10⁻⁴ mol/liter. Thus, a dye-absorption solution was prepared.

Then, a substrate in which the stacked body was formed was immersed into the dye-absorption solution at about 40° C. for 20 hours. Then, after the stacked body was washed with ethanol (manufactured by Aldrich Corp.), drying was performed. Thus, the dye was absorbed to the porous semiconductor layer.

An electrolyte was manufactured in a manner that iodine (manufactured by Aldrich Corp.) having concentration of 0.15 mol/liter, dimethylpropyl imidazole iodide (manufactured by Shikoku Chemicals CORP.) having concentration of 0.8 mol/liter, 3-methylpyrazole (manufactured by Aldrich Corp.) having concentration of 0.5 mol/liter, lithium iodide having concentration of 0.1 mol/liter, and guanidine thiocyanate having concentration of 0.1 mol/liter were dissolved in 3-methoxypropionitrile (manufactured by Aldrich Corp.).

Thus, in a dye-sensitized solar cell having high conversion efficiency, iodine redox which is a general redox pair at the current level is used. However, even when a non-iodine redox pair such as non-corrosive ferricium/ferrocene or CoII/CoIII polypyridyl complex is used, it is possible to suppress an increase of the flow resistance when an electrolyte is injected.

Then, a cover 111 formed from a glass substrate (Corning7059) which has a size of 13 mm×75 mm was coated with an ultraviolet curing material (manufactured by ThreeBond Co., Ltd., model number: 31X-101), and the transparent electrode substrate on which the stacked body was formed, and the cover 111 were adhered to each other. A coated portion with an ultraviolet curing agent was irradiated with an ultraviolet ray by using an ultraviolet illumination lamp (manufactured by EFD Corp., Novacure), and thus, the transparent electrode substrate and the cover 111 were fixed to each other.

Then, the electrolyte was injected from an electrolyte injection hole which had been formed in the cover 111 in advance. After a space formed by the transparent electrode substrate, the cover 111, and the insulating sealing portion 190 was filled with an electrolyte, the electrolyte injection hole was sealed by using ultraviolet curing resin (manufactured by ThreeBond Co., Ltd., model number: 31X-101). Thus, a photoelectric conversion element (single cell) was completed.

An Ag paste (manufactured by FUJIKURA KASEI CO., LTD., product name: DOTITE) was applied onto the transparent electrode substrate of the obtained photoelectric conversion element, and thus a collection electrode unit was formed. In this manner, the photoelectric conversion element in Example 1 was manufactured.

### Example 2

In Example 2, a photoelectric conversion element was manufactured based on Example 1 except that the insulating bonding part 141 was formed to have disposition illustrated in FIGS. 4 and 5.

### Example 3

In Example 3, a photoelectric conversion element was manufactured based on Example 1 except that the insulating bonding part 141 was formed to have disposition illustrated in FIGS. 6 and 7.

### Example 4

In Example 4, a photoelectric conversion element was manufactured based on Example 1 except that the insulating bonding part 141 was formed to have disposition illustrated in FIGS. 6 and 8.

### Comparative Example 1

FIG. 9 is a plan view illustrating a pattern in a plan view of an insulating bonding part of a photoelectric conversion element according to Comparative Example 1. FIG. 9 illustrates only a porous insulating part 140 and an inter-cell insulating part 180. In FIG. 9, Injection direction 1 of a carrier transporting material and Bisector 2 of a short side of a photoelectric conversion part 130 are illustrated. In Comparative Example 1, a photoelectric conversion element was manufactured based on Example 1 except that the insulating bonding part 141 was not formed.

<Evaluation Method and Results>

The photoelectric conversion elements in Examples 1 to 4 and Comparative Example 1 were irradiated with light (AM1.5 solar simulator) having intensity of 1 kW/m², and then photoelectric conversion efficiency was measured. The photoelectric conversion efficiency was obtained in a manner that a value of a short-circuit current value Isc was divided by an area of an aperture area (area surrounded by linking an outer frame of the photoelectric conversion element) of the photoelectric conversion element, and then an open circuit voltage (Voc) and a fill factor (FF) were multiplied by the value obtained by the division.

Table 1 collectively shows an area of the photoelectric conversion part 130, the size and the number of patterns of the insulating bonding part 141, an area occupied by all of insulating bonding parts 141, occupancy of the insulating bonding part 141, and an evaluation result of the photoelectric conversion element, in each of Examples 1 to 4 and Comparative Example 1. The occupancy of the insulating bonding part 141 is a value obtained by dividing an area of the pattern of all of the insulating bonding parts 141 by an area of the second electrode 160 positioned on the porous insulating part 140 and on the inter-cell insulating part 180. Regarding evaluation of the photoelectric conversion element, “good” is shown in a case of being more excellent than the photoelectric conversion element in Comparative Example 1. “same” is shown in a case of being equivalent to the photoelectric conversion element in Comparative Example 1, and “bad” is shown in a case of being worse than the photoelectric conversion element in Comparative Example 1.

TABLE 1

| | | | | | Comparative |
|---|---|---|---|---|---|
| | Example 1 | Example 2 | Example 3 | Example 4 | Example 1 |
| Area (cm²) of | 2.5 | 2.5 | 2.5 | 2.5 | 2.5 |
| photoelectric | | | | | |
| conversion part | | | | | |
| Area (cm²) occupied | 0.35 | 0.54 | 0.54 | 0.94 | — |
| by all of insulating | | | | | |
| bonding parts | | | | | |
| Size (cm) and | half diameter | width 0.1 | width 0.05 | width 0.05 | — |
| number of pattern of | 0.15 | length 5.4 | length 5.4 | length 1.56 | |
| insulating bonding | half circle | number 1 | number 2 | number 12 | |
| parts | number 10 | | | | |
| Occupancy (%) of | 9% | 14% | 14% | 25% | — |
| insulating bonding | | | | | |
| part | | | | | |
| Photoelectric | same | same | same | same | — |
| conversion efficiency | | | | | |
| Non-separation rate | good | good | good | good | — |
| Increase rate of | same | same | same | bad | — |
| injection period of | | | | | |
| carrier transporting | | | | | |
| material | | | | | |

As shown in Table 1, regarding the photoelectric conversion efficiency, each of the photoelectric conversion elements in Examples 1 to 4 was similar to the photoelectric conversion element according to Comparative Example 1. Thus, it could be confirmed that, in a case where an area of a portion at which the photoelectric conversion part 130 and the insulating bonding part 141 overlapped each other was small in a plan view, an influence on the photoelectric conversion efficiency was few. The non-separation rate was lowest in Example 2 in which an interval between insulating bonding parts 141 was narrowest. However, all of the photoelectric conversion elements according to Examples 1 to 4 had non-separation rate which was lower than that in the photoelectric conversion element according to Comparative Example 1. Regarding the increase rate of an injection period of a carrier transporting material, the photoelectric conversion element according to Example 4, in which flow resistance of a carrier transporting material was relatively large was larger than the photoelectric conversion element according to Comparative Example 1. However, the photoelectric conversion elements according to Examples 1 to 3 were similar to the photoelectric conversion element according to Comparative Example 1.

A photoelectric conversion element according to Embodiment 5 of the present invention will be described below. The photoelectric conversion element according to this embodiment is different from the photoelectric conversion element 100 according to Embodiment 1 only in a point of a pattern and disposition of the insulating bonding part. Thus, descriptions for other components will not be repeated.

### Embodiment 5

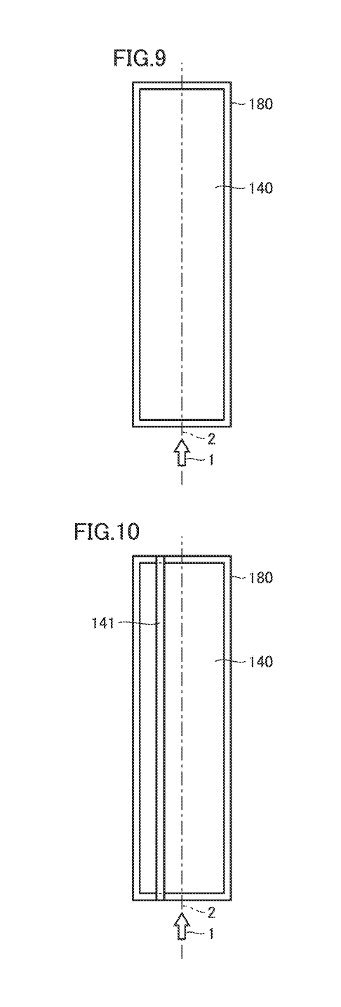

FIG. 10 is a plan view illustrating a pattern in a plan view of an insulating bonding part of a photoelectric conversion element according to Embodiment 5 of the present invention. FIG. 10 illustrates only a porous insulating part 140, an inter-cell insulating part 180, and an insulating bonding part 141. In FIG. 10, Injection direction 1 of a carrier transporting material and Bisector 2 of a short side of a photoelectric conversion part 130 are illustrated.

As illustrated in FIG. 10, in a photoelectric conversion element according to Embodiment 5 of the present invention, one insulating bonding part 141 is provided so as to link short sides of a photoelectric conversion part 130 to each other. The one insulating bonding part 141 is provided so as to have a straight line in a plan view and is positioned to be shifted from Bisector 2 of the short side of the photoelectric conversion part 130.

In this embodiment, one insulating bonding part 141 is provided on an upper surface of the porous insulating part 140. The one insulating bonding part 141 is in contact with a flat portion 161 of a second electrode 160.

One insulating bonding part 141 is brought into contact with the second electrode 160, and thus it is possible to improve bonding strength of the second electrode 160 to the transparent substrate 110 through the insulating bonding part 141, the porous insulating part 140, and the photoelectric conversion part 130. Thus, it is possible to suppress an occurrence of separation of the second electrode 160.

In this embodiment, one insulating bonding part 141 is provided so as to have a straight line shape which is parallel with Injection direction 1 of the carrier transporting material, and thus an increase of flow resistance of the carrier transporting material is suppressed. As a result, it is possible to suppress an increase of an injection time of the carrier transporting material.

A photoelectric conversion element according to Embodiment 6 of the present invention will be described below. The photoelectric conversion element according to this embodiment is different from the photoelectric conversion element 100 according to Embodiment 1 only in a point of a pattern and disposition of the insulating bonding part. Thus, descriptions for other components will not be repeated.

### Embodiment 6

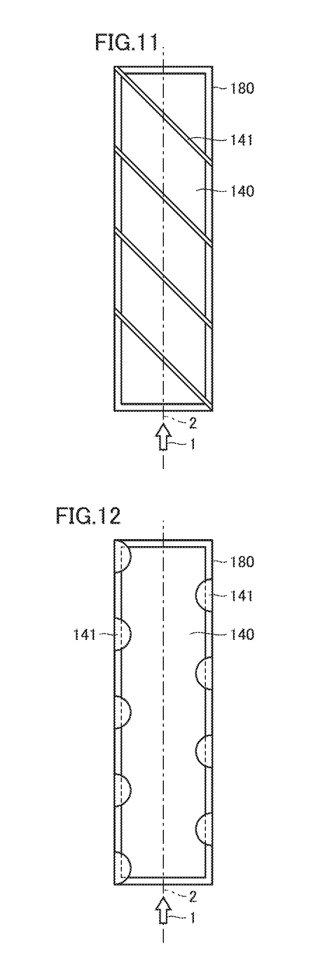

FIG. 11 is a plan view illustrating a pattern in a plan view of an insulating bonding part of a photoelectric conversion element according to Embodiment 6 of the present invention. FIG. 11 illustrates only a porous insulating part 140, an inter-cell insulating part 180, and an insulating bonding part 141. In FIG. 11, Injection direction 1 of a carrier transporting material and Bisector 2 of a short side of a photoelectric conversion part 130 are illustrated.

As illustrated in FIG. 11, in a photoelectric conversion element according to Embodiment 6 of the present invention, a plurality of insulating bonding parts 141 is provided to have a stripe shape which diagonally intersects with a long side of a photoelectric conversion part 130 and links long sides of the photoelectric conversion part 130 to each other, in a plan view.

In this embodiment, each of the plurality of insulating bonding parts 141 is formed along the upper surface of the inter-cell insulating part 180 from the upper surface of the porous insulating part 140. Each of the plurality of insulating bonding parts 141 is in contact with the flat portion 161 of the second electrode 160.

The plurality of insulating bonding parts 141 is caused to be in contact with the inter-cell insulating part 180 and the second electrode 160, and thus it is possible to improve bonding strength to the transparent substrate 110 of the second electrode 160 through the insulating bonding part 141, the inter-cell insulating part 180, and the photoelectric conversion part 130. Thus, it is possible to suppress an occurrence of separation of the second electrode 160.

A photoelectric conversion element according to Embodiment 7 of the present invention will be described below. The photoelectric conversion element according to this embodiment is different from the photoelectric conversion element 100 according to Embodiment 1 only in a point of a pattern and disposition of the insulating bonding part. Thus, descriptions for other components will not be repeated.

### Embodiment 7

FIG. 12 is a plan view illustrating a pattern in a plan view of an insulating bonding part of a photoelectric conversion element according to Embodiment 7 of the present invention. FIG. 12 illustrates only a porous insulating part 140, an inter-cell insulating part 180, and an insulating bonding part 141. In FIG. 12, Injection direction 1 of a carrier transporting material and Bisector 2 of a short side of a photoelectric conversion part 130 are illustrated.

As illustrated in FIG. 12, in a photoelectric conversion element according to Embodiment 7 of the present invention, a plurality of insulating bonding parts 141 is positioned at an interval along each of long sides of a photoelectric conversion part 130 in a plan view. Each of the plurality of insulating bonding parts 141 has a semicircular appearance which has a center on an outer circumference of the inter-cell insulating part 180, in a plan view. A plurality of insulating bonding parts 141 is positioned to have a zigzag shape in a plan view.

In this embodiment, each of the plurality of insulating bonding parts 141 is formed along the upper surface of the inter-cell insulating part 180 from the upper surface of the porous insulating part 140. Each of the plurality of insulating bonding parts 141 is in contact with the flat portion 161 of the second electrode 160.

The plurality of insulating bonding parts 141 is caused to be in contact with the inter-cell insulating part 180 and the second electrode 160, and thus it is possible to improve bonding strength to the transparent substrate 110 of the second electrode 160 through the insulating bonding part 141, the inter-cell insulating part 180, and the photoelectric conversion part 130. Thus, it is possible to suppress an occurrence of separation of the second electrode 160.

Here, Experiment Example 2 in which each of photoelectric conversion elements in Examples 5 to 7 according to Embodiments 5 to 7, and the photoelectric conversion element in Comparative Example 1 was evaluated regarding photoelectric conversion efficiency, a non-separation rate, and an increase rate of an injection period of the carrier transporting material will be described.

### Experiment Example 2

In Experiment Example 2, the photoelectric conversion elements according to Examples 5 to 7 were manufactured similarly to that in Example 1, and photoelectric conversion efficiency, a non-separation rate, and an increase rate of an injection period of a carrier transporting material were evaluated similarly to that in Experiment Example 1.

### Example 5

In Example 5, a photoelectric conversion element was manufactured based on Example 1 except that the insulating bonding part 141 was formed to have disposition illustrated in FIG. 10.

### Example 6

In Example 6, a photoelectric conversion element was manufactured based on Example 1 except that the insulating bonding part 141 was formed to have disposition illustrated in FIG. 11.

### Example 7

In Example 7, a photoelectric conversion element was manufactured based on Example 1 except that the insulating bonding part 141 was formed to have disposition illustrated in FIG. 12.

Table 2 collectively shows an area of the photoelectric conversion part 130, the size and the number of patterns of the insulating bonding part 141, an area occupied by all of insulating bonding parts 141, occupancy of the insulating bonding part 141, and an evaluation result of the photoelectric conversion element, in each of Examples 5 to 7.

TABLE 2

| | Example 5 | Example 6 | Example 7 |
|---|---|---|---|
| Area (cm²) of | 2.5 | 2.5 | 2.5 |
| photoelectric | | | |
| conversion part | | | |
| Area (cm²) occupied | 0.54 | 0.88 | 0.32 |
| by all of insulating | | | |
| bonding parts | | | |
| Size (cm) and | width 0.1 | width 0.03 | half diameter |
| number of pattern of | length 5.4 | length 7.35 | 0.15 |
| insulating bonding | number 1 | number 4 | half circle |
| parts | | | number 9 |
| Occupancy (%) of | 14% | 23% | 8% |
| insulating bonding | | | |
| part | | | |
| Photoelectric | same | same | same |
| conversion efficiency | | | |
| Non-separation rate | good | good | good |
| Increase rate of | same | bad | same |
| injection period of | | | |
| carrier transporting | | | |
| material | | | |

As shown in Table 2, regarding the photoelectric conversion efficiency, each of the photoelectric conversion elements in Examples 5 to 7 was similar to the photoelectric conversion element according to Comparative Example 1. Thus, it could be confirmed that, in a case where an area of a portion at which the photoelectric conversion part 130 and the insulating bonding part 141 overlapped each other was small in a plan view, an influence on the photoelectric conversion efficiency was few. Regarding the non-separation rate, all of the photoelectric conversion elements according to Examples 5 to 7 were lower than the photoelectric conversion element according to Comparative Example 1. Regarding the increase rate of an injection period of a carrier transporting material, the photoelectric conversion element according to Example 6, in which flow resistance of a carrier transporting material was relatively large was larger than the photoelectric conversion element according to Comparative Example 1. However, the photoelectric conversion elements according to Examples 5 and 7 were similar to the photoelectric conversion element according to Comparative Example 1.

Here, Experiment Example 3 in which each of photoelectric conversion elements in Examples 8 and 9, and the photoelectric conversion element in Comparative Example 2 was evaluated regarding photoelectric conversion efficiency, a non-separation rate, and an increase rate of an injection period of the carrier transporting material will be described. The photoelectric conversion elements in Examples 8 and 9 are different from the photoelectric conversion element according to Examples 2 and 3 and the photoelectric conversion element according to Comparative Example 1, in only a point of the length of a short side of the photoelectric conversion part. In each of the photoelectric conversion elements according to Examples 8 and 9, and the photoelectric conversion element according to Comparative Example 2, the length of the short side of the photoelectric conversion part 130 is 10 mm.

### Experiment Example 3

In Experiment Example 3, the photoelectric conversion elements according to Examples 8 and 9, and Comparative Example 2 were manufactured similarly to that in Example 1, and photoelectric conversion efficiency, a non-separation rate, and an increase rate of an injection period of a carrier transporting material were evaluated similarly to that in Experiment Example 1.

### Example 8

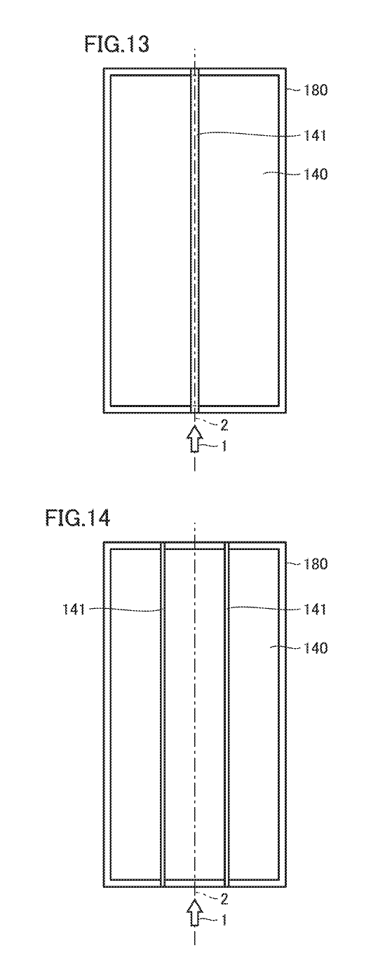

FIG. 13 is a plan view illustrating a pattern in a plan view of an insulating bonding part of a photoelectric conversion element according to Example 8. FIG. 13 illustrates only a porous insulating part 140, an inter-cell insulating part 180, and an insulating bonding part 141. In FIG. 13, Injection direction 1 of a carrier transporting material and Bisector 2 of a short side of a photoelectric conversion part 130 are illustrated. In Example 8, a photoelectric conversion element was manufactured based on Example 1 except that the insulating bonding part 141 was formed to have disposition illustrated in FIG. 13.

### Example 9

FIG. 14 is a plan view illustrating a pattern in a plan view of an insulating bonding part of a photoelectric conversion element according to Example 9. FIG. 14 illustrates only a porous insulating part 140, an inter-cell insulating part 180, and an insulating bonding part 141. In FIG. 14, Injection direction 1 of a carrier transporting material and Bisector 2 of a short side of a photoelectric conversion part 130 are illustrated. In Example 9, a photoelectric conversion element was manufactured based on Example 1 except that the insulating bonding part 141 was formed to have disposition illustrated in FIG. 14.

### Comparative Example 2

FIG. 15 is a plan view illustrating a pattern in a plan view of an insulating bonding part of a photoelectric conversion element according to Comparative Example 2. FIG. 15 illustrates only a porous insulating part 140 and an inter-cell insulating part 180. In FIG. 15, Injection direction 1 of a carrier transporting material and Bisector 2 of a short side of a photoelectric conversion part 130 are illustrated. In Comparative Example 2, a photoelectric conversion element was manufactured based on Example 1 except that the insulating bonding part 141 was not formed, and the length of the short side of the photoelectric conversion part 130 was set to 10 mm.

Table 3 collectively shows an area of the photoelectric conversion part 130, the size and the number of patterns of the insulating bonding part 141, an area occupied by all of insulating bonding parts 141, occupancy of the insulating bonding part 141, and an evaluation result of the photoelectric conversion element, in each of Examples 8 and 9 and Comparative Example 2.

TABLE 3

| | | | Comparative |
|---|---|---|---|
| | Example 8 | Example 9 | Example 2 |
| Area (cm²) of | 5.0 | 5.0 | 5.0 |
| photoelectric | | | |
| conversion part | | | |
| Area (cm²) occupied | 0.54 | 0.54 | — |
| by all of insulating | | | |
| bonding parts | | | |
| Size (cm) and | width 0.1 | width 0.5 | — |
| number of pattern of | length 5.4 | length 5.4 | |
| insulating bonding | number 1 | number 2 | |
| parts | | | |
| Occupancy (%) of | 8% | 8% | — |
| insulating bonding | | | |
| part | | | |
| Photoelectric | same | same | bad |
| conversion efficiency | | | |
| Non-separation rate | good | good | bad |
| Increase rate of | same | same | same |
| injection period of | | | |
| carrier transporting | | | |
| material | | | |

As shown in Table 3, regarding the photoelectric conversion efficiency, each of the photoelectric conversion elements in Examples 8 and 9 was similar to the photoelectric conversion element according to Comparative Example 1, and the photoelectric conversion element according to Comparative Example 2 was lower than the photoelectric conversion element according to Comparative Example 1. The reason that the photoelectric conversion efficiency in the photoelectric conversion element according to Comparative Example 2 is degraded is because a distance in which electrons flows in the photoelectric conversion part 130 is increased, and thus FF is degraded. Regarding the non-separation rate, all of the photoelectric conversion elements according to Examples 8 and 9 were lower than the photoelectric conversion element according to Comparative Example 1. Regarding the increase rate of an injection period of a carrier transporting material, the photoelectric conversion elements according to Examples 8 and 9 were similar to the photoelectric conversion element according to Comparative Example 1.

Here, Experiment Example 4 in which each of photoelectric conversion elements in Examples 10 to 12 was evaluated regarding photoelectric conversion efficiency, a non-separation rate, and an increase rate of an injection period of the carrier transporting material will be described. The photoelectric conversion elements in Examples 10 to 12 are different from the photoelectric conversion element according to Example 9, in only a point of the width of the insulating bonding part.

### Experiment Example 4

In Experiment Example 4, the photoelectric conversion elements according to Examples 10 to 12 were manufactured similarly to that in Example 1, and photoelectric conversion efficiency, a non-separation rate, and an increase rate of an injection period of a carrier transporting material were evaluated similarly to that in Experiment Example 1.

### Example 10

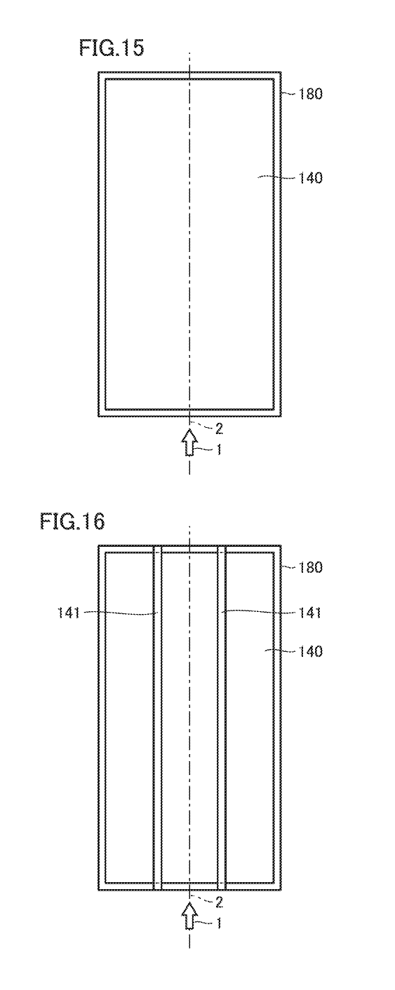

FIG. 16 is a plan view illustrating a pattern in a plan view of an insulating bonding part of a photoelectric conversion element according to Example 10. FIG. 16 illustrates only a porous insulating part 140, an inter-cell insulating part 180, and an insulating bonding part 141. In FIG. 16, Injection direction 1 of a carrier transporting material and Bisector 2 of a short side of a photoelectric conversion part 130 are illustrated. In Example 10, a photoelectric conversion element was manufactured based on Example 1 except that the insulating bonding part 141 was disposed as illustrated in FIG. 16, and one insulating bonding part 141 was formed to have a width of 0.09 mm.

### Example 11

FIG. 17 is a plan view illustrating a pattern in a plan view of an insulating bonding part of a photoelectric conversion element according to Example 11. FIG. 17 illustrates only a porous insulating part 140, an inter-cell insulating part 180, and an insulating bonding part 141. In FIG. 17, Injection direction 1 of a carrier transporting material and Bisector 2 of a short side of a photoelectric conversion part 130 are illustrated. In Example 11, a photoelectric conversion element was manufactured based on Example 1 except that the insulating bonding part 141 was disposed as illustrated in FIG. 17, and one insulating bonding part 141 was formed to have a width of 0.18 mm.

### Example 12

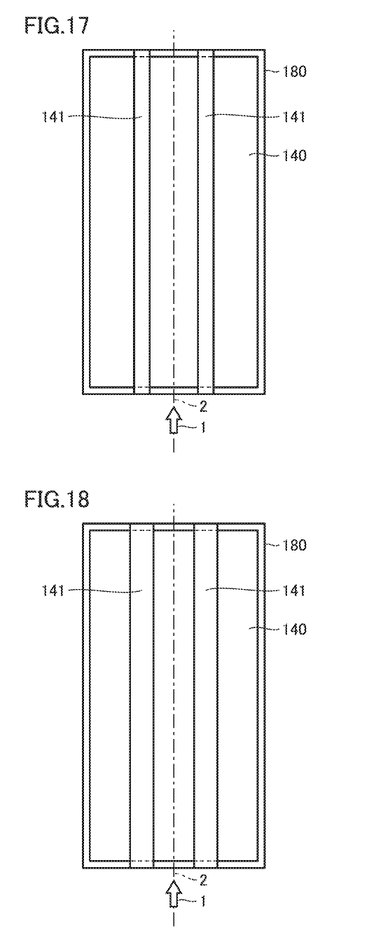

FIG. 18 is a plan view illustrating a pattern in a plan view of an insulating bonding part of a photoelectric conversion element according to Example 12. FIG. 18 illustrates only a porous insulating part 140 and an inter-cell insulating part 180. In FIG. 18, Injection direction 1 of a carrier transporting material and Bisector 2 of a short side of a photoelectric conversion part 130 are illustrated. In Example 12, a photoelectric conversion element was manufactured based on Example 1 except that the insulating bonding part 141 was disposed as illustrated in FIG. 18, and one insulating bonding part 141 was formed to have a width of 0.3 mm.

Table 4 collectively shows an area of the photoelectric conversion part 130, the size and the number of patterns of the insulating bonding part 141, an area occupied by all of insulating bonding parts 141, occupancy of the insulating bonding part 141, and an evaluation result of the photoelectric conversion element, in each of Examples 10 to 12.

TABLE 4

| | Example 10 | Example 11 | Example 12 |
|---|---|---|---|
| Area (cm²) of | 5.0 | 5.0 | 5.0 |
| photoelectric | | | |
| conversion part | | | |
| Area (cm²) occupied | 0.97 | 1.94 | 3.24 |
| by all of insulating | | | |
| bonding parts | | | |
| Size (cm) and | width 0.09 | width 0.18 | width 0.3 |
| number of pattern of | length 5.4 | length 5.4 | length 5.4 |
| insulating bonding | number 2 | number 2 | number 2 |
| parts | | | |
| Occupancy (%) of | 15% | 30% | 50% |
| insulating bonding | | | |
| part | | | |
| Photoelectric | same | same | bad |
| conversion efficiency | | | |
| Non-separation rate | good | good | good |
| Increase rate of | bad | bad | bad |
| injection period of | | | |
| carrier transporting | | | |
| material | | | |

As shown in Table 4, regarding the photoelectric conversion efficiency, each of the photoelectric conversion elements in Examples 10 and 11 was similar to the photoelectric conversion element according to Comparative Example 1, and the photoelectric conversion element according to Example 12 was lower than the photoelectric conversion element according to Comparative Example 1. Thus, it could be confirmed that, if the occupancy of the insulating bonding part 141 was equal to or less than 30%, an influence on the photoelectric conversion efficiency was not large. Regarding the non-separation rate, all of the photoelectric conversion elements according to Examples 10 to 12 were lower than the photoelectric conversion element according to Comparative Example 1. Thus, it could be confirmed that, if the occupancy of the insulating bonding part 141 was equal to or more than 8%, it was possible to reduce the non-separation rate, in a case where the length of the short side of the photoelectric conversion part 130 was equal to or less than 10 mm as in the photoelectric conversion elements according to Examples 8 to 12. Regarding the increase rate of an injection period of a carrier transporting material, the photoelectric conversion elements according to Examples 10 to 12 were larger than the photoelectric conversion element according to Comparative Example 1.

A photoelectric conversion element according to Embodiment 8 of the present invention will be described below. The photoelectric conversion element according to this embodiment is different from the photoelectric conversion element 100 according to Embodiment 1 only in a point of a pattern and disposition of the insulating bonding part. Thus, descriptions for other components will not be repeated.

### Embodiment 8

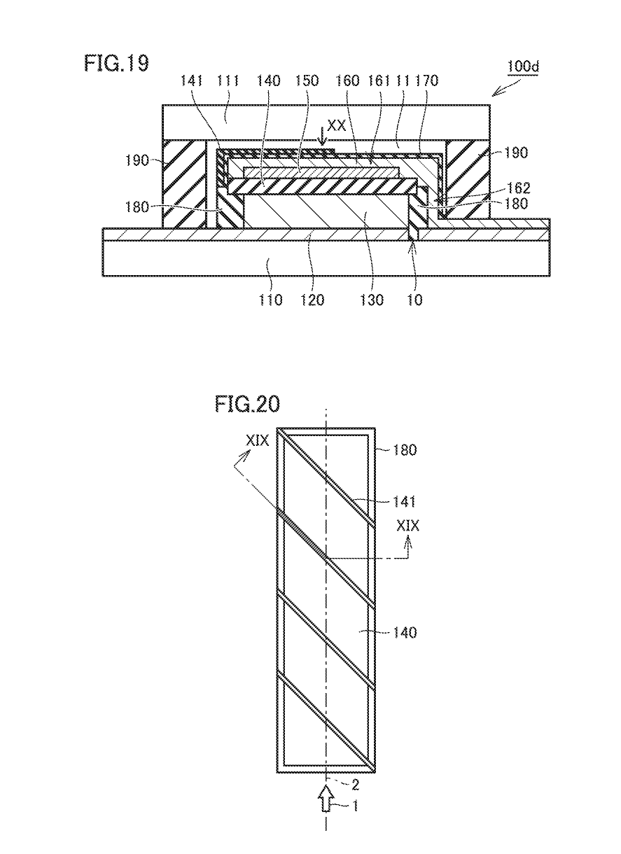

FIG. 19 is a sectional view illustrating a configuration of a photoelectric conversion element according to Embodiment 8 of the present invention. FIG. 20 is a plan view when a pattern in a plan view of an insulating bonding part of the photoelectric conversion element in FIG. 19 is viewed from a direction indicated by an arrow XX. FIG. 19 illustrates only a porous insulating part 140, an inter-cell insulating part 180, and an insulating bonding part 141. In FIG. 19, Injection direction 1 of a carrier transporting material and Bisector 2 of a short side of a photoelectric conversion part 130 are illustrated.

As illustrated in FIGS. 19 and 20, in a photoelectric conversion element 100d according to Embodiment 8 of the present invention, four insulating bonding parts 141 are provided to have a stripe shape which diagonally intersects with a long side of a photoelectric conversion part 130 and links long sides of the photoelectric conversion part 130 to each other, in a plan view.

In this embodiment, each of a plurality of insulating bonding parts 141 is provided from an upper surface of the protective film 170 along an upper surface of the inter-cell insulating part 180. That is, in each of the plurality of insulating bonding parts 141, a portion of the insulating bonding part 141 is positioned on the flat portion 161 of the second electrode 160. Each of the plurality of insulating bonding parts 141 is indirectly in contact with the flat portion 161 of the second electrode 160, with the protective film 170 interposed between the insulating bonding part 141 and the second electrode 160.

A manufacturing method of the photoelectric conversion element according to this embodiment is similar to the manufacturing method of the photoelectric conversion element 100 according to Embodiment 1, except that the porous insulating part 140 and the second electrode 160 are provided, and then the insulating bonding part 141 is provided.

The insulating bonding part 141 having a thermal expansion coefficient lower than that of the second electrode 160 is provided on the second electrode 160, and thus it is possible to suppress thermal shrinkage of the second electrode 160. The plurality of insulating bonding parts 141 is caused to be in contact with the inter-cell insulating part 180 and the second electrode 160, and thus it is possible to improve bonding strength to the transparent substrate 110 of the second electrode 160 through the insulating bonding part 141, the inter-cell insulating part 180, and the photoelectric conversion part 130. Thus, it is possible to suppress an occurrence of separation of the second electrode 160.

A photoelectric conversion element according to Embodiment 9 of the present invention will be described below. The photoelectric conversion element according to this embodiment is different from the photoelectric conversion element 100 according to Embodiment 1 in only a point of the pattern of the insulating bonding part. Thus, descriptions for other components will not be repeated.

### Embodiment 9

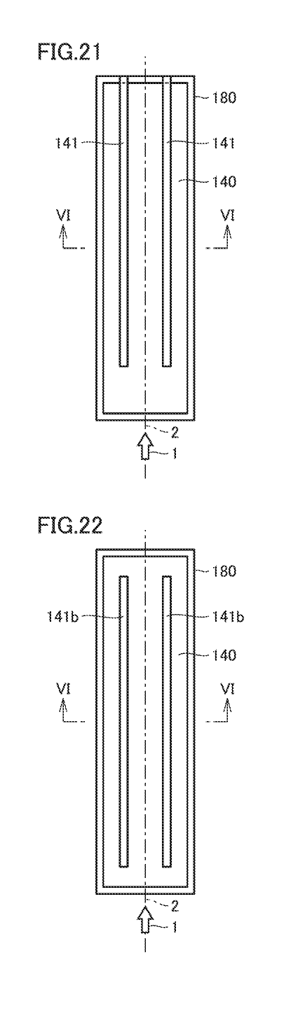

FIG. 21 is a plan view illustrating a pattern in a plan view of an insulating bonding part of a photoelectric conversion element according to Embodiment 9 of the present invention. FIG. 21 illustrates only a porous insulating part 140, an inter-cell insulating part 180, and an insulating bonding part 141. In FIG. 21, Injection direction 1 of a carrier transporting material and Bisector 2 of a short side of a photoelectric conversion part 130 are illustrated.

As illustrated in FIG. 21, in a photoelectric conversion element according to Embodiment 9 of the present invention, two insulating bonding parts 141 are provided in parallel with each other, so as to be extended from one short side of a photoelectric conversion part 130 toward the other short side thereof, in a plan view. Each of two insulating bonding parts 141 is linked to only one short side of the photoelectric conversion part 130 in a plan view. Two insulating bonding parts 141 are positioned to have a relationship of line symmetry based on Bisector 2, in a plan view.

In this embodiment, two insulating bonding parts 141 are provided on an upper surface of the porous insulating part 140. The two insulating bonding parts 141 are in contact with the flat portion 161 of the second electrode 160.

Two insulating bonding parts 141 are brought into contact with the second electrode 160, and thus it is possible to improve bonding strength of the second electrode 160 to the transparent substrate 110 through the insulating bonding part 141, the porous insulating part 140, and the photoelectric conversion part 130. Thus, it is possible to suppress an occurrence of separation of the second electrode 160.

In this embodiment, two insulating bonding part 141 are provided so as to have a straight line shape which is parallel with Injection direction 1 of the carrier transporting material, and thus an increase of flow resistance of the carrier transporting material is suppressed. As a result, it is possible to suppress an increase of an injection time of the carrier transporting material.

Here, Experiment Example 5 in which each of photoelectric conversion elements in Examples 13 and 14 according to Embodiments 8 and 9, and the photoelectric conversion element in Comparative Example 3 was evaluated regarding photoelectric conversion efficiency, a non-separation rate, and an increase rate of an injection period of the carrier transporting material will be described. In each of the photoelectric conversion elements according to Examples 13 and 14, and the photoelectric conversion element according to Comparative Example 3, the length of the short side of the photoelectric conversion part 130 is 5 mm.

### Experiment Example 5

In Experiment Example 5, the photoelectric conversion elements according to Examples 13 and 14, and Comparative Example 3 were manufactured similarly to that in Example 1, and photoelectric conversion efficiency, a non-separation rate, and an increase rate of an injection period of a carrier transporting material were evaluated similarly to that in Experiment Example 1.

### Example 13

In Example 13 a photoelectric conversion element was manufactured based on Example 1 except that the insulating bonding part 141 was formed to have disposition illustrated in FIGS. 19 and 20.

### Example 14

In Example 14, a photoelectric conversion element was manufactured based on Example 1 except that the insulating bonding part 141 was formed to have disposition illustrated in FIG. 21.

### Comparative Example 3

FIG. 22 is a plan view illustrating a pattern in a plan view of an insulating bonding part of a photoelectric conversion element according to Comparative Example 3. FIG. 22 illustrates only a porous insulating part 140 and an inter-cell insulating part 180. In FIG. 22, Injection direction 1 of a carrier transporting material and Bisector 2 of a short side of a photoelectric conversion part 130 are illustrated. In Comparative Example 3, two insulating bonding parts 141b are provided in parallel with each other, so as to be extended from one short side of the photoelectric conversion part 130 toward the other short side. Each of the two insulating bonding parts 141 is not linked to both of the short sides of the photoelectric conversion part 130 in a plan view. Two insulating bonding parts 141b are positioned to have a relationship of line symmetry based on Bisector 2, in a plan view. In Comparative Example 3, a photoelectric conversion element was manufactured based on Example 1 except that the insulating bonding part 141b was formed to have disposition illustrated in FIG. 22.

Table 5 collectively shows an area of the photoelectric conversion part 130, the size and the number of patterns of the insulating bonding parts 141 and 141b, an area occupied by all of insulating bonding parts 141 and 141b, occupancy of the insulating bonding parts 141 and 141b, and an evaluation result of the photoelectric conversion element, in each of Examples 13 and 14 and Comparative Example 3.

TABLE 5

| | | | Comparative |
|---|---|---|---|
| | Example 13 | Example 14 | Example 3 |
| Area (cm²) of | 2.5 | 2.5 | 2.5 |
| photoelectric | | | |
| conversion part | | | |
| Area (cm²) occupied | 0.88 | 0.80 | 0.80 |
| by all of insulating | | | |
| bonding parts | | | |
| Size (cm) and | width 0.03 | width 0.1 | width 0.1 |
| number of pattern of | length 7.35 | length 4.0 | length 4.0 |
| insulating bonding | number 4 | number 2 | number 2 |
| parts | | | |
| Occupancy (%) of | 23% | 21% | 21% |
| insulating bonding | | | |
| part | | | |
| Photoelectric | good | same | same |
| conversion efficiency | | | |
| Non-separation rate | good | good | same |
| Increase rate of | bad | same | same |
| injection period of | | | |
| carrier transporting | | | |
| material | | | |

As shown in Table 5, regarding the photoelectric conversion efficiency, the photoelectric conversion elements in Example 13 was higher than the photoelectric conversion element according to Comparative Example 1, and each of the photoelectric conversion elements according to Example 14 and Comparative Example 3 was similar to the photoelectric conversion element according to Comparative Example 1. Regarding the non-separation rate, the photoelectric conversion element according to Comparative Example 3 was similar to the photoelectric conversion element according to Comparative Example 1. However, all of the photoelectric conversion elements according to Examples 13 and 14 were lower than the photoelectric conversion element according to Comparative Example 1. Regarding the increase rate of an injection period of a carrier transporting material, the photoelectric conversion element according to Example 13, in which the insulating bonding part 141 was positioned between the second electrode 160 and the cover 111, and thus flow resistance of a carrier transporting material was relatively large was larger than the photoelectric conversion element according to Comparative Example 1. However, the photoelectric conversion elements according to Example 14 and Comparative Example 3 were similar to the photoelectric conversion element according to Comparative Example 1.

In a case where the second electrode 160 was formed at Ti, in a range of the thickness of the protective film 170, which was 300 Å to 400 Å, even though the protective film 170 was positioned between the insulating bonding part 141 and the second electrode 160, it was possible to suppress an occurrence of separation of the second electrode 160.

A photoelectric conversion element according to Embodiment 10 of the present invention will be described below. The photoelectric conversion element according to this embodiment is different from the photoelectric conversion element 100 according to Embodiment 1 only in a point of a pattern and disposition of the insulating bonding part. Thus, descriptions for other components will not be repeated.

### Embodiment 10

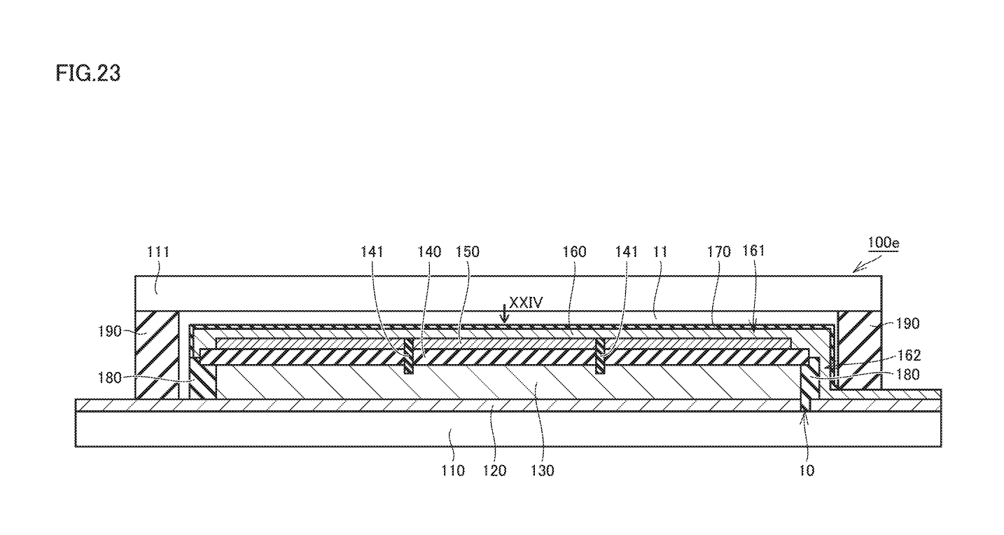

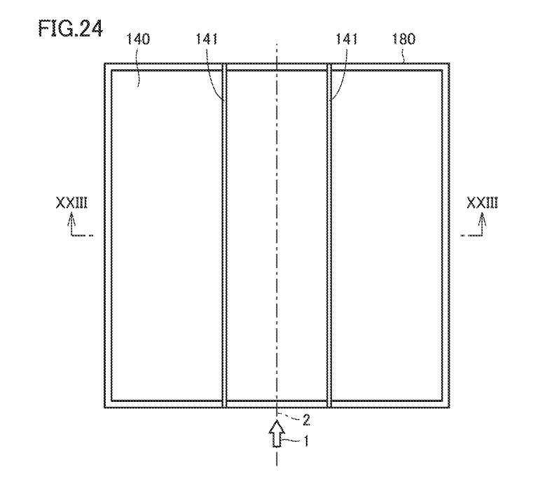

FIG. 23 is a sectional view illustrating a configuration of a photoelectric conversion element according to Embodiment 10 of the present invention. FIG. 24 is a plan view when a pattern in a plan view of an insulating bonding part of the photoelectric conversion element in FIG. 23 is viewed from a direction indicated by an arrow XXIV. FIG. 24 illustrates only a porous insulating part 140, an inter-cell insulating part 180, and an insulating bonding part 141. In FIG. 24, Injection direction 1 of a carrier transporting material and Bisector 2 of a short side of a photoelectric conversion part 130 are illustrated.

As illustrated in FIGS. 23 and 24, in a photoelectric conversion element 100e according to Embodiment 10 of the present invention, two insulating bonding parts 141 are provided in parallel with each other so as to link short sides of a photoelectric conversion part 130, in a plan view. Two insulating bonding parts 141 are positioned to have a relationship of line symmetry based on Bisector 2, in a plan view.

As illustrated in FIG. 23, in this embodiment, each of two insulating bonding parts 141 is provided so as to pass through the porous insulating part 140 and to reach the inside of the photoelectric conversion part 130. That is, the porous insulating part 140 is in contact with the photoelectric conversion part 130. The two insulating bonding parts 141 are in contact with the flat portion 161 of the second electrode 160.

In a manufacturing method of the photoelectric conversion element according to this embodiment, in a process of providing the photoelectric conversion part 130, when a titanium oxide paste containing particles which has a large particle diameter is printed fourth time, the porous semiconductor layer is provided by using a screen in which a position corresponding to a position at which the insulating bonding part 141 is formed is closed. Similarly, the porous insulating part 140 is provided by using a screen in which the position corresponding to a position at which the insulating bonding part 141 is formed is closed. Further, the insulating bonding part 141 is provided by using a screen in which the pattern illustrated in FIG. 24 is opened. Then, the second electrode 160 is provided. The manufacturing method of the photoelectric conversion element according to this embodiment is similar to the manufacturing method of the photoelectric conversion element 100 according to Embodiment 1 except for the above process.

Two insulating bonding parts 141 are brought into contact with the second electrode 160 and the photoelectric conversion part 130, and thus it is possible to improve bonding strength of the second electrode 160 to the transparent substrate 110 through the insulating bonding part 141 and the photoelectric conversion part 130. Thus, it is possible to suppress an occurrence of separation of the second electrode 160. In particular, in the inside of the photoelectric conversion part 130, the insulating bonding part 141 is provided so as to come into contact with a porous semiconductor layer formed from particles which are relatively small, and thus it is possible to improve a bonding force between the photoelectric conversion part 130 and the insulating bonding part 141.

In this embodiment, two insulating bonding part 141 are provided so as to have a straight line shape which is parallel with Injection direction 1 of the carrier transporting material, and thus an increase of flow resistance of the carrier transporting material is suppressed. As a result, it is possible to suppress an increase of an injection time of the carrier transporting material.

Here, Experiment Example 6 in which the photoelectric conversion element in Example 16 was evaluated regarding photoelectric conversion efficiency, a non-separation rate, and an increase rate of an injection period of the carrier transporting material will be described. The photoelectric conversion element in Example 16 is different from the photoelectric conversion element in Example 15 according to Embodiment 10 and the photoelectric conversion element in Example 12, in only a point of the length of a short side of the photoelectric conversion part. In each of the photoelectric conversion elements according to Examples 15 and 16, the length of the short side of the photoelectric conversion part 130 is 50 mm.

### Experiment Example 6

In Experiment Example 6, the photoelectric conversion elements according to Examples 15 and 16 were manufactured similarly to that in Example 1, and photoelectric conversion efficiency, a non-separation rate, and an increase rate of an injection period of a carrier transporting material were evaluated similarly to that in Experiment Example 1.

### Example 15

In Example 15, a photoelectric conversion element was manufactured based on Example 1 except that the insulating bonding part 141 was formed to have disposition illustrated in FIGS. 23 and 24.

### Example 16

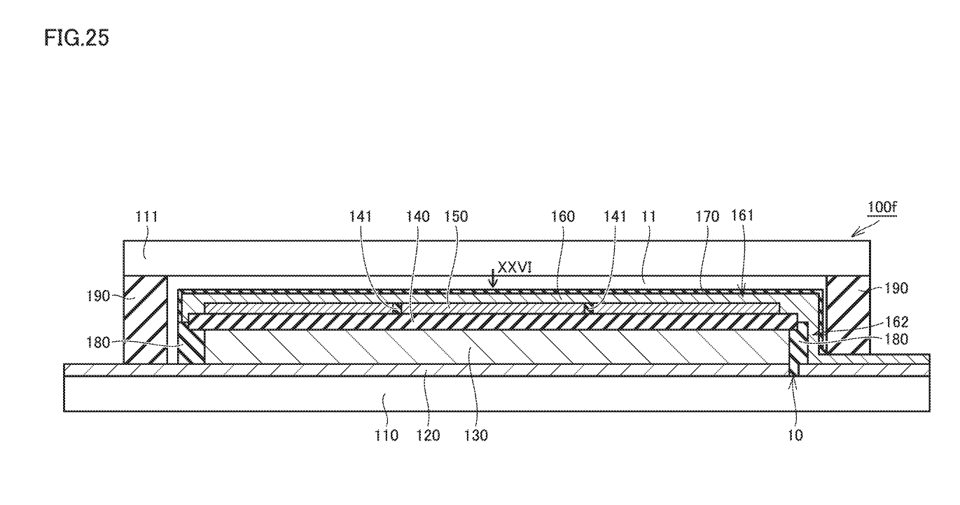

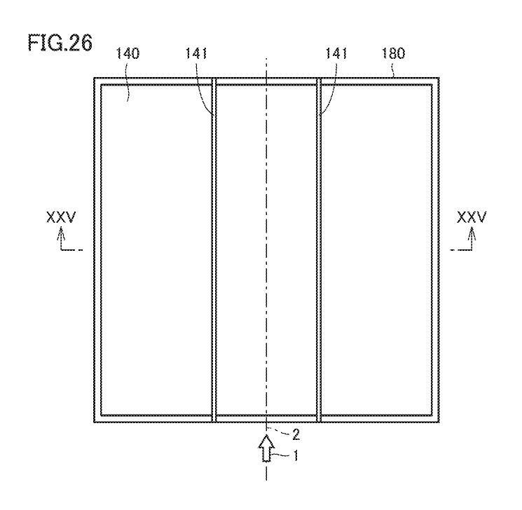

FIG. 25 is a sectional view illustrating a configuration of a photoelectric conversion element according to Example 16. FIG. 26 is a plan view when a pattern in a plan view of an insulating bonding part of the photoelectric conversion element in FIG. 25 is viewed from a direction indicated by an arrow XXVI. FIG. 26 illustrates only a porous insulating part 140 and an inter-cell insulating part 180. In FIG. 26, Injection direction 1 of a carrier transporting material and Bisector 2 of a short side of a photoelectric conversion part 130 are illustrated. In Example 16, a photoelectric conversion element was manufactured based on Example 1 except that the insulating bonding part 141 was formed to have disposition illustrated in FIGS. 25 and 26.

As illustrated in FIGS. 25 and 26, in a photoelectric conversion element 100f according to Example 16, two insulating bonding parts 141 are provided in parallel with each other, so as to link short sides of the photoelectric conversion part 130 to each other, in a plan view. Two insulating bonding parts 141 are positioned to have a relationship of line symmetry based on Bisector 2, in a plan view.

As illustrated in FIG. 25, in this embodiment, two insulating bonding parts 141 are provided on an upper surface of the porous insulating part 140. The two insulating bonding parts 141 are in contact with the flat portion 161 of the second electrode 160.

Table 6 collectively shows an area of the photoelectric conversion part 130, the size and the number of patterns of the insulating bonding part 141, an area occupied by all of insulating bonding parts 141, occupancy of the insulating bonding part 141, and an evaluation result of the photoelectric conversion element, in each of Examples 15 and 16.

TABLE 6

| | Example 15 | Example 16 |
|---|---|---|
| Area (cm²) of | 25.0 | 25.0 |
| photoelectric | | |
| conversion part | | |
| Area (cm²) occupied | 3.24 | 3.24 |
| by all of insulating | | |
| bonding parts | | |
| Size (cm) and | width 0.3 | width 0.3 |
| number of pattern of | length 5.4 | length 5.4 |
| insulating bonding | number 2 | number 2 |
| parts | | |
| Occupancy (%) of | 12% | 12% |
| insulating bonding | | |
| part | | |
| Photoelectric | bad | bad |
| conversion efficiency | | |
| Non-separation rate | good | good |
| Increase rate of | same | same |
| injection period of | | |
| carrier transporting | | |
| material | | |

As shown in Table 6, regarding the photoelectric conversion efficiency, each of the photoelectric conversion elements in Examples 15 and 16 was lower than the photoelectric conversion element according to Comparative Example 1. The reason that the photoelectric conversion efficiency in the photoelectric conversion element according to Example 15 is degraded is because the insulating bonding part 141 is provided to reach the inside of the photoelectric conversion part 130, and thus the volume of the porous semiconductor layer is reduced, and the absorbed amount of dye in the porous semiconductor layer is decreased.

Regarding the non-separation rate, all of the photoelectric conversion elements according to Examples 15 and 16 were lower than the photoelectric conversion element according to Comparative Example 1. In the photoelectric conversion element 100f according to Example 16, separation of the second electrode 160 was not recognized, but separation in the first electrode 120 was recognized. In the photoelectric conversion element 100e according to Example 15, separation of neither of the first electrode 120 and the second electrode 160 was recognized. Regarding the increase rate of an injection period of a carrier transporting material, the photoelectric conversion elements according to Examples 15 and 16 were similar to the photoelectric conversion element according to Comparative Example 1.

A photoelectric conversion element module according to Embodiment 11 of the present invention, which includes the photoelectric conversion element in any of Embodiments 1 to 10 will be described below.

### Embodiment 11

<Photoelectric Conversion Element Module>

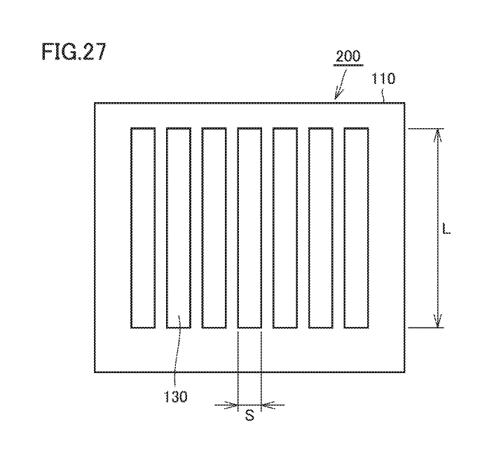

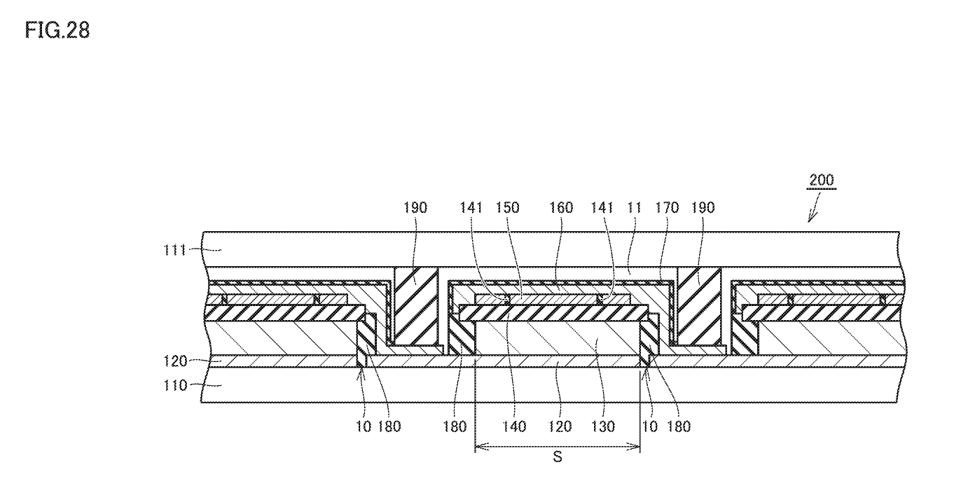

FIG. 27 is a plan view illustrating an appearance of a photoelectric conversion element module according to Embodiment 11 of the present invention. FIG. 28 is a sectional view illustrating a configuration of the photoelectric conversion element module according to Embodiment 11 of the present invention. FIG. 27 illustrates only a transparent substrate 110 and a photoelectric conversion part 130 of a photoelectric conversion element module 200 according to Embodiment 11 of the present invention. FIG. 28 illustrates a sectional view of a photoelectric conversion element module in a case of including the photoelectric conversion element according to Embodiment 3. FIGS. 27 and 28 illustrate the length S of a short side of the photoelectric conversion part, and the length L of a long side of the photoelectric conversion part. FIG. 28 illustrates a sectional view of a photoelectric conversion element module in a case of including the photoelectric conversion element according to Embodiment 3.

As illustrated in FIGS. 27 and 28, in a photoelectric conversion element module 200, seven photoelectric conversion elements in any of Embodiment 1 to 10 are connected to each other in series. In detail, eight first electrodes 120 are provided on one sheet of transparent substrate 110, so as to be separate from the scribe line 10. The photoelectric conversion part 130, the porous insulating part 140, the catalyst layer 150, the second electrode 160, and the carrier transporting part 11 which are configured by absorbing a dye and the like to the porous semiconductor layer are provided on each of the first electrodes 120. The inter-cell insulating part 180 is provided on the scribe line 10.

In such a photoelectric conversion element module 200, a second electrode 160 in one photoelectric conversion element among adjacent photoelectric conversion elements is extended toward a first electrode 120 in another photoelectric conversion element through the inter-cell insulating part 180, and is electrically connected to the first electrode 120. Thus, the adjacent photoelectric conversion elements are connected to each other in series.

As illustrated in FIGS. 27 and 28, in the photoelectric conversion element module 200, one sheet of cover 111 is provided on the second electrode 160 so as to face the transparent substrate 110, and the insulating sealing portion 190 is provided between the transparent substrate 110 and the cover 111. The photoelectric conversion element is sealed in a region surrounded by the transparent substrate 110, the cover 111, and the insulating sealing portion 190.

The carrier transporting part 11 filled with the carrier transporting material is formed in the region surrounded by the transparent substrate 110, the cover 111, and the insulating sealing portion 190. However, since photoelectric conversion elements which are adjacent to each other are partitioned by the insulating sealing portion 190, coming and going of the carrier transporting material between the adjacent photoelectric conversion elements is prevented. As described above, the insulating sealing portion 190 has a function of partitioning photoelectric conversion elements which are adjacent to each other.

In the photoelectric conversion element module 200, it is preferable that a current collection electrode is provided on an outside of the insulating sealing portion 190 on the transparent substrate 110. In addition, it is preferable that the current collection electrode comes into contact with first electrodes 120 of photoelectric conversion elements positioned at both ends of the current collection electrode. Thus, it is possible to easily extract a current from the photoelectric conversion element module 200 to the outside.

In the photoelectric conversion element module 200, the number of photoelectric conversion elements constituting the photoelectric conversion element module 200 is not limited to seven. A plurality of photoelectric conversion elements may be electrically connected to each other in parallel with each other. Further, in a case where the photoelectric conversion element module 200 includes three photoelectric conversion elements or more, the photoelectric conversion element module 200 may include photoelectric conversion elements which are connected to each other in series, and photoelectric conversion elements which are connected to each other in parallel. The photoelectric conversion element module 200 is not necessarily limited to a case of including only a photoelectric conversion element having the above configuration, and may include at least one photoelectric conversion element having the above configuration. That is, the photoelectric conversion element module 200 may include a photoelectric conversion element having a configuration which is different from the above-described configuration.

Here, Experiment Example 7 in which each of the photoelectric conversion element module in Example 17 and the photoelectric conversion element module according to Comparative Example 4 was evaluated regarding photoelectric conversion efficiency, a non-separation rate, and an increase rate of an injection period of the carrier transporting material will be described. The photoelectric conversion element module in Example 17 is configured in a manner that seven photoelectric conversion elements in Example 9 are connected to each other in series. The photoelectric conversion element module according to Comparative Example 4 is configured in a manner that seven photoelectric conversion elements in Comparative Example 2 are connected to each other in series.

### Experiment Example 7

In Experiment Example 7, the photoelectric conversion element modules according to Example 17 and Comparative Example 4 were manufactured similarly to that in Example 1, and photoelectric conversion efficiency, a non-separation rate, and an increase rate of an injection period of a carrier transporting material were evaluated similarly to that in Experiment Example 1.

### Example 17

In Example 17, a photoelectric conversion element module according to Example 17 was manufactured by connecting seven photoelectric conversion elements according to Example 9 to each other in series.

### Comparative Example 4

In Comparative Example 4, a photoelectric conversion element module according to Example 17 was manufactured by connecting seven photoelectric conversion elements according to Comparative Example 2 to each other in series.

Table 7 collectively shows an area of the photoelectric conversion part 130, the size and the number of patterns of the insulating bonding part 141, an area occupied by all of insulating bonding parts 141, occupancy of the insulating bonding part 141, and an evaluation result of the photoelectric conversion element, in the photoelectric conversion element included in the photoelectric conversion element module in each of Example 17 and Comparative Example 4.

TABLE 7

| | | Comparative |
|---|---|---|
| | Example 17 | Example 4 |
| Area (cm²) of | 5.0 | 5.0 |
| photoelectric | | |
| conversion part | | |
| Area (cm²) occupied | 0.54 | — |
| by all of insulating | | |
| bonding parts | | |
| Size (cm) and | width 0.05 | — |
| number of pattern of | length 5.4 | |
| insulating bonding | number 2 | |
| parts | | |
| Occupancy (%) of | 8% | — |
| insulating bonding | | |
| part | | |
| Photoelectric | good | bad |
| conversion efficiency | | |
| Non-separation rate | good | bad |
| Increase rate of | same | same |
| injection period of | | |
| carrier transporting | | |
| material | | |

As shown in Table 7, regarding the photoelectric conversion efficiency, the photoelectric conversion element included in the photoelectric conversion element module according to Comparative Example 4 was lower than the photoelectric conversion element according to Comparative Example 1. However, the photoelectric conversion element included in the photoelectric conversion element module according to Example 17 is higher than the photoelectric conversion element according to Comparative Example 1. The reason that the photoelectric conversion efficiency in the photoelectric conversion element included in the photoelectric conversion element module according to Comparative Example 4 is degraded is because many microcracks which do not reach visible separation are provided, and thus a gap between the catalyst layer 150 and the photoelectric conversion part 130 is increased or the protective film 170 is excessively formed on the photoelectric conversion part 130 side, and accordingly, equivalent series resistance of the photoelectric conversion element is increased. The reason that the photoelectric conversion efficiency of the photoelectric conversion element included in the photoelectric conversion element module according to Example 17 is increased is because variation of the photoelectric conversion efficiency in the photoelectric conversion element is suppressed by the insulating bonding part 141.

Regarding the non-separation rate, the photoelectric conversion element included in the photoelectric conversion element module according to Comparative Example 4 was higher than the photoelectric conversion element according to Comparative Example 1. However, the photoelectric conversion element included in the photoelectric conversion element module according to Example 17 was lower than the photoelectric conversion element according to Comparative Example 1. Regarding the increase rate of an injection period of a carrier transporting material, each of the photoelectric conversion elements included in the photoelectric conversion element modules according to Example 17 and Comparative Example 4 was similar to the photoelectric conversion element according to Comparative Example 1.

The photoelectric conversion element according to any of Embodiment 1 to 10, or the photoelectric conversion element module according to Embodiment 11 is embedded in various systems, and is provided for various services. For example, the photoelectric conversion element module is embedded and used in a human detection sensor system of a device and the like which generates sound for warning an approaching person in a platform of a station or a boundary of an area in which entrance is restricted.

The human detection sensor system includes the photoelectric conversion element according to any of Embodiment 1 to 10 or the photoelectric conversion element module according to Embodiment 11, a power generation unit including a voltage adjusting unit, an infrared-ray detection sensor configured to drive by power obtained in the power generation unit, a signal processing unit configured to drive by power obtained in the power generation unit and to process a signal obtained by the infrared-ray detection sensor, and an interface configured to output a signal processed in the signal processing unit.

As another example, for example, the photoelectric conversion element module is embedded and used in an information processing system of a door and the like having an electric lock which is attached thereto and uses FeliCa (registered trademark) as a card key.

The information processing system includes the photoelectric conversion element according to any of Embodiment 1 to 10 or the photoelectric conversion element module according to Embodiment 11, a power generation unit including a voltage adjusting unit, a wireless signal reception unit configured to drive by power obtained in the power generation unit, a signal processing unit configured to drive by power obtained in the power generation unit and to process a signal obtained by the wireless signal reception unit, a wireless signal output unit configured to drive by power obtained in the power generation unit and to output a signal processed in the signal processing unit, and a driving unit configured to receive a signal output by the wireless signal output unit and to perform a mechanical operation.

In the above system including the photoelectric conversion element according to any of Embodiment 1 to 10 or the photoelectric conversion element module according to Embodiment 11, a proportion defective occurring by separation of the second electrode in the photoelectric conversion element and the photoelectric conversion element module is reduced, and thus reliability of the system is improved.

The embodiments and examples disclosed this time are just an example in all points, and are considered not to be limited. The scope of the present invention is shown by Claims, not the above descriptions. It is intended that all changes in the meanings equivalent to the scope of Claims and the range may be included.

### REFERENCE SIGNS LIST

10 SCRIBE LINE
11 CARRIER TRANSPORTING PART
100, 100a, 100b, 100c, 100d, 100e, 100f PHOTOELECTRIC CONVERSION ELEMENT
110 TRANSPARENT SUBSTRATE
111 COVER
120 FIRST ELECTRODE
130 PHOTOELECTRIC CONVERSION PART
140 POROUS INSULATING PART
141, 141b INSULATING BONDING PART
150 CATALYST LAYER
160 SECOND ELECTRODE
161 FLAT PORTION
162 BENT PORTION
170 PROTECTIVE FILM
180 INTER-CELL INSULATING PART
190 INSULATING SEALING PORTION
200 PHOTOELECTRIC CONVERSION ELEMENT MODULE

1. A photoelectric conversion element comprising:
a transparent substrate having a light-receiving surface;
a cover disposed to face the transparent substrate;
a plurality of first electrodes formed on a surface of the transparent substrate facing the cover;
a frame-shaped insulating sealing part that is disposed between the plurality of first electrodes and the cover and defines a space inside the photoelectric conversion element;
a photoelectric conversion part formed on an upper surface of a first electrode among the plurality of first electrodes in the space;
a second electrode formed in the space, which includes a flat portion that faces an upper surface of the photoelectric conversion part and a lower surface of the cover, and a bent portion that is bent at an end of the flat portion toward another first electrode adjacent to the first electrode among the plurality of first electrodes and is electrically connected to the another first electrode;
a porous insulating part that is positioned between the photoelectric conversion part and the second electrode, and insulates the photoelectric conversion part from the second electrode;
an inter-cell insulating part that is in contact with at least a portion of an outer circumference of the photoelectric conversion part and insulates the first electrode from the second electrode;
a carrier transporting part with which the space is filled; and
an insulating bonding part that has at least a portion positioned between the porous insulating part and the cover and is brought into contact with the inter-cell insulating part and with a portion of the flat portion so as to bond the inter-cell insulating part and the second electrode to each other.

2. The photoelectric conversion element according to claim 1, wherein
the insulating bonding part comes into contact with the first electrode.

3. The photoelectric conversion element according to claim 1, wherein
the insulating bonding part comes into contact with the photoelectric conversion part.

4. The photoelectric conversion element according to claim 1, wherein
a portion of the insulating bonding part is positioned on the flat portion.

5. A photoelectric conversion element module comprising:
a plurality of the photoelectric conversion elements according to claim 1, which are electrically connected to each other in series or in parallel.

6. The photoelectric conversion element according to claim 2, wherein
a portion of the insulating bonding part is positioned on the flat portion.

7. The photoelectric conversion element according to claim 1, wherein
the insulating bonding part include at least one selected from a group of silicone resin, epoxy resin, polyisobutylene resin, hot melt resin and glass frit.

8. The photoelectric conversion element according to claim 1, wherein
the inter-cell insulating part include at least one selected from a group of silicone resin, epoxy resin, polyisobutylene resin, hot melt resin and glass frit.
